(19) United States
(12) Patent Application Publication
(10) Pub. No.: US 2021/0070923 A1
(43) Pub. Date: Mar. 11, 2021

(54) Multicoat paint system, method of producing it, and use thereof

(71) Applicant: BASF Coatings GmbH, Munster (DE)

(72) Inventors: Norbert Low, Neustadt/Aisch (DE); Vincent Cook, Munster (DE); Jorn Lavalaye, Wurzburg (DE)

(21) Appl. No.: 16/949,877

(22) Filed: Nov. 18, 2020

Related U.S. Application Data
(63) Continuation of application No. 13/265,742, filed on Oct. 21, 2011, now abandoned.

(30) Foreign Application Priority Data
Apr. 21, 2009 (DE) 10 2009 018 216.0

(51) Int. Cl. C08G 59/14; B05D 7/00; C08L 63/00; C08G 59/50

(52) U.S. Cl. CPC C08G 59/1483; B05D 7/534; C08L 63/00; C08G 59/5086; B05D 2201/00; B05D 2202/00; B05D 7/51; B05D 7/53; B05D 2451/00; Y10T 428/31511

(57) ABSTRACT

The present invention relates to multicoat paint systems comprising basecoats and clearcoats with high solids fractions that each comprise at least one sulfonic acid compound of formula (I) or formula (II). The invention further relates to a method of producing these multicoat paint systems and to their use, and also to substrates coated with the multicoat paint system. The invention relates, furthermore, to the use of the sulfonic acid compounds of formula (I) and formula (II) in basecoats and clearcoats with high solids fractions.

### FIELD OF THE INVENTION

The present invention relates to multicoat paint systems, to a method of producing them, to use thereof, and to substrates coated with these multicoat paint systems.

### PRIOR ART

The well-established solventborne coating materials, especially those known as basecoat and clearcoat materials, and the single-coat or multicoat color and/or effect paint systems produced using them have very good performance properties.

However, the continually growing technical and aesthetic demands of the market, particularly the demands of the automobile manufacturers and their customers, require continual onward development of the technical and aesthetic level attained so far.

In particular there is a need to provide new coating compositions which allow the production of multicoat paint systems which, when baked, exhibit little or no tendencies toward yellowing, especially under overbake conditions. At the same time, however, the advantages acquired by virtue of the known basecoat and clearcoat materials and the multicoat paint systems produced from them are not to be lost, but instead are to be retained at least to the same extent and preferably to a greater extent.

Multicoat paint systems composed of basecoat and clearcoat are widespread in the automobile industry. They are used on account of their outstanding profiles of properties, such as scratch resistance, chemical resistance, and weather resistance, and also on account of their high gloss. For reasons of environmental protection, furthermore, there is a need to provide coating compositions having a lower and lower solvent content and hence a higher and higher solids content (high solids, HS for short).

High-solids clearcoat materials which comply with the limits for volatile organic compounds (VOC) and which possess the high scratch resistance the customer demands are based predominantly on carbamate-containing binder systems, which in combination with monomeric crosslinking resins such as hexa(methoxymethyl)melamine (HMMM) or melamines with mixed etherification, and with polymerized binders, form a dense network. The volatile organic compounds embrace the solvents and also volatile elimination products from film-forming reactions (cf. Römpp Lexikon Lacke and Druckfarben, Georg Thieme Verlag Stuttgart/New York 1998, ISBN 3-13-776001-1, page 612, entry heading “Volatile organic compounds” (VOC)).

The basecoats in the multicoat paint systems typically comprise a binder and a crosslinking agent. The binder frequently possesses hydroxy-functional groups on a polymeric network. Crosslinking agents used are typically monomeric crosslinking resins such as hexa(methoxymethyl)melamine (HMMM) or melamines with mixed etherification.

The basecoat and clearcoat materials with monomeric melamine resins as crosslinking agents further comprise strong acid catalysts, thus ensuring the crosslinking of the monomeric units. Acid catalysts employed in this context are aromatic sulfonic acid (e.g., para-toluenesulfonic acid pTSA, dinonylnaphthalene-sulfonic acid DNNSA, dodecylbenzenesulfonic acid DDBNS), phenyl phosphate acid, butyl phosphate esters, and hydroxy phosphate esters. The acid catalysts are blocked predominantly with an amine group, hence ensuring the stability and the keeping properties of the coating systems. Commonly, tertiary-alkylated or heterocyclic amines are used, such as 2-amino-2-methylpropanol, diisopropanolamine, dimethyloxazolidine, trimethylamine, etc. The amine here forms a complex with the acid catalyst, thereby preventing premature reaction between binder and melamine. When the multicoat system is baked, the amine complex undergoes dissociation, thereby releasing the acid functionality of the catalyst and, as a proton donor, catalyzing the reaction of melamine with binder.

Multicoat paint systems are produced by first applying a pigmented basecoat material and then, after a brief flash-off time, without a baking step (wet-on-wet method), applying a clearcoat material over the basecoat material, and then baking basecoat and clearcoat together.

In the innovative 3-wet-coating methods, a basecoat material is applied as a primer substitute. After a brief flash-off time, a pigmented basecoat material is applied over it, and, after a further brief flash-off time, without a baking step (wet-on-wet-on-wet method), a clearcoat material is applied. Subsequently all three films (basecoat I+II and clearcoat) are baked jointly. Examples of 3-wet methods are described in WO 2006/062 666 A1 and in application EP 1940977.

One possible phenomenon in both the wet-on-wet method and the wet-on-wet-on-wet method is the yellowing of at least one of the coats, predominantly of the upper coats.

In particular the overbaking of multicoat paint systems, as may occur at any time in OEM finishing, is accompanied by the phenomenon of yellowing. According to DIN 6167:1980-01, yellowing occurs when the material in question is found to exhibit a notable yellow value, such as, for instance, in white, light-hued, or else colored high-gloss and satin-gloss finishes, on the basis of influences such as radiation, temperature, moisture, and chemical reactions (Römpp Lexikon Lacke und Druckfarben, page 601, entry heading “Vergilbung” [Yellowing]).

Overbaking is a term for the baking of a coating material with supply of energy in excess (baking time and/or baking temperature are exceeded) of that needed for complete crosslinking (Römpp Lexikon Lacke und Druckfarben, page 585, entry heading “Überbrennen” [Overbaking]).

From U.S. Pat. No. 5,288,820 it is known that reaction of an amine with an acetoacetate group and an aldehyde group gives rise to dihydropyridine derivatives, which are known to have a very strong yellow coloration.

U.S. Pat. No. 4,369,301 describes a two-component polyurethane resin with hydrazide groups whereby the yellowing is reduced.

U.S. Pat. No. 5,112,931 uses hydrazide groups to reduce the yellowing in one-component acrylates with blocked polyisocyanate coating materials.

The yellowing of the multicoat paint system on, say, the steel body is extremely undesirable, since in a later operation the plastic components are installed onto the body, resulting in problems with regard to consistency of hue (color harmony).

European patent EP 0377931 B1 describes sulfonic acid compounds for paints and coating compositions, especially clearcoat materials, which are suitable for electrospray applications and exhibit a high storage stability. When these compositions are stored, decolorization occurs to less of an extent.

Solventborne high-solids coating compositions nowadays require the use of low-viscosity binders and also of melamine-based crosslinking resins of low reactivity.

To allow a polymeric, chemically resistant network to form from the oligomeric starting constituents at reduced baking temperatures and/or in reduced baking times, the use of catalysts is a necessity. Acrylates, polyurethanes, and polyesters with reactive functional groups such as, for example, hydroxyl, carbamate or amine groups can react with melamine ureas. The selection of suitable catalysts may result in a shortened baking time, lower baking temperature, improved adhesion properties, and greater robustness with respect to yellowing reactions. The use of new, weight-saving materials such as aluminum or plastic in vehicle construction results in different heating profiles for these materials. Sharp temperature fluctuations on the basis of different heat transport by the materials may lead, particularly in instances of unintended overbaking, to severe yellowing in light, solid-color or metallic multicoat paint systems.

High-solids basecoat and clearcoat materials are typically composed of monomeric crosslinking resins such as hexa(methoxymethyl)melamine (HMMM) or melamines with mixed etherification. The crosslinking reaction with hydroxy- or carbamate-functional groups takes place ideally with strong acid catalysts such as dodecylbenzylsulfonic acid (DDBSA), dinonylnaphthalenesulfonic acid (DNNSA) or para-toluenesulfonic acid (p-TSA). Polymeric crosslinking resins with a high NH group content, which are more reactive, react more effectively with blocked catalysts.

For high-solids coating materials, a marked change in viscosity on storage is undesirable, since the processing of these materials would require high levels of addition of solvent standardizers. That would entail a sharp reduction in the solids, resulting in an increased VOC level.

### Problem

The problem on which the present invention is based was that of eliminating the above-described disadvantages of the prior art. The intention was to provide multicoat paint systems, based on high-solids basecoat and clearcoat materials, which, especially on overbaking, exhibit less pronounced yellowing reactions than the multicoat paint systems of the prior art. At the same time the high-solids basecoat and clearcoat materials ought to have good stability on storage, and especially no increase in viscosity. Consequently the coating materials after storage ought to have a viscosity allowing them to be applied without further addition of solvent, by spray application, for example.

The task was therefore to find a multicoat paint system which is composed of high-solids basecoat and clearcoat materials and in which there is a balance between low yellowing of the paint system and high storage stability of the coating materials.

Furthermore, the advantages achieved by means of the known high-solids basecoat and clearcoat materials, and the basecoats and clearcoats produced from them, such as good flow, low bit count, and high consistency of hue ought not to be lost but instead ought to be retained at least to the same extent and preferably to a greater extent. The paint systems ought, furthermore, to exhibit good adhesion.

The resulting multicoat paint system ought in particular to exhibit very little haze, if any, and a very good overall visual appearance. Furthermore, the multicoat paint systems ought to be free from film defects such as mudcracking, clouds (areas of light/dark shading), and bits. Furthermore, the multicoat paint systems ought not to exhibit optical defects such as abrasion marks, for example.

The intention was, further, to provide a method of producing these multicoat paint systems.

It was further intended that substrates of metal and/or plastic should be provided, coated with the multicoat paint system.

### Solution to the Problem

Surprisingly, multicoat paint systems have been found which feature lower yellowing, particularly on overbaking, in conjunction with good storage stability of the high-solids basecoat and clearcoat materials (the systems being referred to below as multicoat paint systems of the invention).

The multicoat paint systems of the invention comprise
i. at least one basecoat of a nonaqueous basecoat material having a solids fraction of at least 35% by weight, based on the total weight of the basecoat material, and
ii. at least one clearcoat of a nonaqueous clearcoat material having a solids fraction of at least 50% by weight, based on the total weight of the clearcoat material,

wherein the basecoat material and the clearcoat material each contain 0.5% to 3.0% by weight, based on the total weight of the respective coating material,

A. of at least one epoxy-sulfonic acid compound of the formula (I)

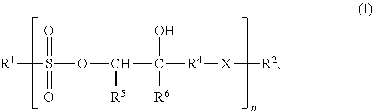

in which

n is 1 to 10,

R¹ is a monovalent or divalent alkyl or alkylene radical having 1 to 18 C atoms or is a monoalkylated or dialkylated phenyl or naphthyl radical having in each case 1 to 18 C atoms,

R⁵ and R⁶ independently are a hydrogen atom or an alkyl radical having 1 to 12 C atoms, or R⁵ and R⁶ together are a cycloalkyl radical having 6 to 12 C atoms, and either
a. R⁴ is a hydrogen atom and the radicals R² and X are absent, or
b. R⁴ is a methylene radical,
   R² is a hydrogen atom, a monovalent or polyvalent alkyl radical having 1 to 18 C atoms, a bisphenol A radical or bisphenol F radical, it being possible for the radicals to be substituted, and
   X is a carbonyl group or an oxygen atom, X being optional,

the compound according to formula (I) having a number-average molecular weight of 350 to 2000 g/mol, and, where n>1, at least one of the radicals R¹ or R² is at least divalent, or

B. of at least one epoxy-isocyanate-blocked sulfonic acid compound of the formula (II)

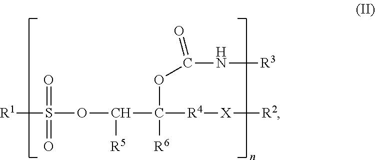

in which R¹, R², R⁴, R⁵, R⁶, X, and n have the same definition as in the compound of the formula (I) and

R³ is an alkyl, alkenyl, cycloalkyl or aryl radical having 1 to 18 C atoms or is a polymer radical, it being possible for R³ to be substituted, and, where n>1, at least one of the radicals R¹, R² or R³ is at least divalent,

the compound according to formula (II) having a number-average molecular weight of at least 1000 g/mol.

Particularly surprising here was that, on overbaking, there is a distinct reduction in yellowing in conjunction with good storage stability on the part of the coating materials especially when both the clearcoat material and the basecoat material each include at least one sulfonic acid compound of formulae (I) and/or (II).

Furthermore, the basecoats and clearcoats show good flow, minimal bit count, and high consistency of color, and also good adhesion.

The multicoat paint systems of the invention display good haze and a very good overall visual appearance. Moreover, the multicoat paint systems are free from film defects such as mudcracking, clouds (instances of light/dark shading), and bits. Furthermore, the multicoat paint systems do not exhibit any optical defects.

Sulfonic acid compounds of the formula (II) are described in detail in European patent EP 0377931 B1. Sulfonic acid compounds of the formula (I) are described in connection with the preparation of the compounds of the formula (II) likewise in European patent EP 0377931 B1.

The radical R³ is an optionally substituted alkyl, alkenyl, cycloalkyl or aryl radical having 1 to 18 C atoms, or a polymer radical. The polymer radical R³ may also carry ester, ether, isocyanate and/or isocyanate-based groups. Examples of suitable polymer radicals R³ are radicals R³ which on reaction of a compound of the formula (I) with an isocyanate OCN—R³ are retained as radicals R³ in the formula (II). Examples of suitable isocyanates OCN—R³ are hexamethylene diisocyanate (HDI), trimethylhexane diisocyanate, isophorone diisocyanate (IPDI), tolylene diisocyanate (TDI), methylene-dianiline-based diisocyanates such as, for example, diphenylmethane 4,4′-diisocyanate, bis(4-isocyanatocyclohexyl)methane or tetramethylxylene diisocyanate; polyesters or polyethers having a terminal isocyanate group, such as, for example, the reaction product of one mole of a polypropylene glycol with two moles of isophorone diisocyanate, or the reaction product of a polyesterdiol formed from neopentyl glycol and adipic acid with an excess of isophorone diisocyanate.

For the purposes of this invention the basecoat materials which are included in the multicoat paint system of the invention with a solids fraction of at least 35% by weight are also described as high-solids basecoat materials. Similarly, the clearcoat materials with a solids fraction of at least 50% by weight are referred to as high-solids clearcoat materials. The solids fraction of the basecoat and clearcoat materials is determined in accordance with DIN ISO 3251 with an initial mass of 1.0 g in a test duration of 60 minutes at a temperature of 125° C.

The present invention further provides a method of producing the multicoat paint systems. Furthermore, the invention also provides for the use of sulfonic acid compounds of the formulae (I) and/or (II) as catalysts in high-solids basecoat and clearcoat materials for producing the multicoat paint systems of the invention. The invention, finally, provides substrates of metal and/or plastic which are coated with the multicoat paint system of the invention.

### DETAILED DESCRIPTION OF THE INVENTION

The preferred embodiments of this invention are described by the dependent claims.

The multicoat paint system of the invention comprises at least one basecoat of a nonaqueous basecoat material having a solids fraction of at least 35% by weight, based on the total weight of the basecoat material, and at least one clearcoat of a nonaqueous clearcoat material having a solids fraction of at least 50% by weight, based on the total weight of the clearcoat material, wherein the basecoat material and the clearcoat material each contain 0.5% to 3.0% by weight, based on the total weight of the respective coating material, of at least one epoxy-sulfonic acid compound of the formula (I) or of at least one epoxy-isocyanate-blocked sulfonic acid compound of the formula (II).

The basecoat material or materials and also the clearcoat material or materials of the multicoat paint system of the invention are also referred to as coating compositions of the multicoat paint system of the invention.

The multicoat paint systems of the invention may also be constructed from high-solids basecoat and clearcoat materials which independently of one another comprise at least one compound of the formula (I) and at least one compound of the formula (II).

Preferably the basecoat and/or clearcoat materials of the multicoat paint systems of the invention, in each case independently of one another, each contain 1.5% to 3.0% by weight, more preferably 1.8% to 2.7% by weight, of at least one compound of formula (I) and/or formula (II).

The compound of the formula (I) has a number-average molecular weight of 350 to 2000 g/mol, preferably of 500 to 1800 g/mol. Compounds of the formula (II) preferably have a number-average molecular weight of 1000 to 4000 g/mol, more preferably of 1000 to 3000 g/mol. The number-average molecular weight is determined by means of gel permeation chromatography in accordance with DIN 55672-1 (2007-08 edition) for THF-soluble polymers, using tetrahydrofuran as eluent. Calibration is performed using polystyrene standards.

Advantageously a coating composition of the multicoat paint system of the invention comprises at least one compound of the formulae (I) or (II) with n being 1 to 5, preferably with n=1. With particular advantage at least one basecoat material and at least one clearcoat material of the multicoat paint system of the invention each comprise at least one compound of the formula (I) or (II) with n being 1 to 5, preferably n=1.

In another preferred embodiment R¹ in the compounds of the formula (I) and (II) is a para-methylphenyl radical, a dodecylphenyl radical or a dinonylnaphthyl radical. Particularly preferred are para-methylphenyl and dodecylphenyl radicals.

In one preferred embodiment the basecoat material of the multicoat paint system of the invention additionally contains
a. 15%-50% by weight of at least one binder,
b. 5%-30% by weight of at least one melamine resin derivative as crosslinking agent,
c. 0.5%-49% by weight of at least one colorant,
d. 30%-65% by weight of at least one organic solvent,
e. 0.05%-40% by weight of at least one auxiliary or additive,

based in each case on the total weight of the basecoat material, the weight fractions of all of the constituents of the basecoat material adding to 100%.

The basecoat material of the multicoat paint system of the invention comprises as additive preferably at least one constituent selected from the group consisting of polymer microparticles, inorganic particles, waxes and waxlike compounds.

In one preferred embodiment the clearcoat material of the multicoat paint system of the invention additionally contains
a. 15%-50% by weight of at least one binder,
b. 5%-30% by weight of at least one melamine resin derivative as crosslinking agent,
c. 30%-50% by weight of at least one organic solvent,
d. 0.05%-40% by weight of at least one auxiliary or additive,

based in each case on the total weight of the clearcoat material, the weight fractions of all of the constituents of the clearcoat material adding to 100%. The clearcoat material of the multicoat paint system of the invention may further comprise catalysts, such as commercial tin catalysts and/or phosphoric acid catalysts, for example.

The multicoat paint systems of the invention typically have a construction such that a substrate has had first a primer and, if appropriate, a surfacer applied to it. Atop these there is at least one basecoat of a basecoat material of the multicoat paint system of the invention, and over that at least one clearcoat of a clearcoat material of the multicoat paint system of the invention.

The substrates are typically provided with a primer and, if appropriate, a surfacer, which are applied using the customary methods, such as electrodeposition coating, dipping, knifecoating, spraying, rolling or the like. Preferably the primer is at least partly or fully cured before basecoat and clearcoat materials are applied. The curing of the primer and/or surfacer takes place typically by heating to a temperature between 80 and 170° C. for a time of 3 to 30 minutes.

The multicoat paint system of the invention is applied preferably to substrates of metal and/or plastic.

Over the primer and/or the surfacer coat there are at least one basecoat material and at least one clearcoat material applied of the multicoat paint system of the invention.

In one embodiment the multicoat paint system comprises at least one further basecoat of a basecoat material having a solids content of at least 35% by weight, based on the total weight of the coating material, which comprises one or more identical or different compounds according to formula (I) and/or formula (II).

The multicoat paint system of the invention may also comprise at least one further basecoat of a basecoat material BI which contains neither compounds according to formula (I) nor compounds according to formula (II). The basecoat material BI has a solids content, based on the total weight of the basecoat material, of at least 35% by weight.

In one preferred embodiment the multicoat paint system has a construction such that the topmost coating is a clearcoat of a clearcoat material of the multicoat paint system of the invention. Below it is a basecoat of a basecoat material of the multicoat paint system of the invention. Accordingly it is preferred for both topmost coats of the multicoat paint system of the invention each to include at least one compound of the formula (I) or (II). With particular preference the multicoat paint system of the invention comprises one or two basecoats and a clearcoat.

Coatings formed from two basecoat materials and one clearcoat material can be cured in a 3-wet method.

Basecoat and clearcoat materials of the multicoat paint system of the invention are applied by means of customary methods of applying liquid coating compositions, such as, for example, dipping, knifecoating, spraying, rolling or the like, but in particular by means of spraying. It is preferred to employ spray application methods, such as, for example, compressed-air spraying, airless spraying, high-speed rotation, or electrostatic spray application (ESTA), where appropriate in conjunction with hot spray application such as hot-air spraying, for example. It is particularly advantageous to apply a basecoat material in a first application by ESTA and in a second application pneumatically.

Preferably the applied basecoat material is briefly flashed off or briefly dried, generally at a temperature between 30 and less than 100° C. for a time of 1 to 15 minutes. After that the clearcoat material is applied.

The applied basecoat material and the applied clearcoat material are thermally cured in unison. Where the clearcoat material is additionally curable with actinic radiation, there follows an aftercure by exposure to actinic radiation.

Curing may take place after a certain rest time. This time may have a duration of 30 seconds to 2 hours, preferably 1 minute to 1 hour, and more particularly 1 to 45 minutes. The purpose of the rest time, for example, is for the flow and degassing of the coating films or for the evaporation of volatile constituents. The rest time may be shortened and/or assisted through the application of elevated temperatures of up to 90° C. and/or through a reduced air moisture content <10 g water/kg air, provided this does not entail any damage or change to the coating films, such as premature complete crosslinking, for instance.

Curing takes place typically at a temperature between 90 and 160° C. for a time of 15 to 90 minutes.

For the drying and/or conditioning of the wet basecoat and of the wet clearcoat, it is preferred to use thermal and/or convection techniques, involving the use of customary and known apparatus such as tunnel ovens, IR and NIR heaters, fans, and blowing tunnels. These forms of apparatus may also be combined with one another.

In the multicoat paint systems of the invention, the basecoat generally has a dry film thickness of 3 to 40 μm, preferably of 5 to 30 μm, and in particular 7 to 25 μm, and the clearcoat generally has a dry film thickness of 10 to 120 μm, preferably of 30 to 80 μm, more particularly 40 to 70 μm.

The further basecoat, where present, of a basecoat material BI, generally has a dry film thickness of 3 to 40 μm, preferably of 5 to 30 μm, and with particular preference of 7 to 25 μm.

The invention additionally provides a method of producing multicoat paint systems, which involves applying, in this order
a. first at least one basecoat material having a solids fraction of at least 35% by weight, based on the total weight of the basecoat material, and
b. subsequently at least one clearcoat material having a solids fraction of at least 50% by weight, based on the total weight of the clearcoat material,

to a substrate, the basecoat material and the clearcoat material each containing 0.5% to 3.0% by weight, based on the total weight of the respective coating material, of at least one compound of the formula (I) or at least one compound of the formula (II). Preferably the basecoat of the basecoat material and the concluding clearcoat of the clearcoat material form two successive coats. For preferred embodiments, refer to the basecoat and clearcoat materials of the multicoat paint system of the invention.

In another embodiment the invention provides a method of producing multicoat paint systems, which involves applying, in this order
a. first at least one basecoat material BI which contains neither compounds according to formula (I) nor compounds according to formula (II),
b. subsequently at least one basecoat material having a solids fraction of at least 35% by weight, based on the total weight of the basecoat material, and
c. thereafter at least one clearcoat material having a solids fraction of at least 50% by weight, based on the total weight of the clearcoat material,

to a substrate, the basecoat material of step b. and the clearcoat material each containing 0.5% to 3.0% by weight, based on the total weight of the respective coating material, of at least one compound of the formula (I) or at least one compound of the formula (II). Preferably the basecoat of the basecoat material of step b. and the concluding clearcoat of the clearcoat material form two successive coats. For preferred embodiments, refer to the basecoat and clearcoat materials of the multicoat paint system of the invention.

The basecoat material BI has a solids content, based on the total weight of the basecoat material BI, of at least 35% by weight.

Furthermore, the invention provides for the use of sulfonic acid compounds of the formula (I) and/or of the formula (II) as catalysts in basecoat materials having a solids content of at least 35% by weight, based on the total weight of the basecoat material, and clearcoat materials having a solids content of at least 50% by weight, based on the total weight of the clearcoat material, for producing multicoat paint systems. The catalysts of the formulae (I) and (II), as proton donors, catalyze the reaction of melamine with binder. For preferred embodiments, refer to the basecoat and clearcoat materials of the multicoat paint system of the invention.

The invention additionally embraces substrates of metal and/or plastic which have been coated with the multicoat paint system of the invention.

A further aspect of the invention is the use of the multicoat paint systems of the invention for automotive OEM finishing, for utility vehicle finishing and automotive refinish, for the coating of components for boatbuilding and aircraft construction or of components for household and electrical appliances or parts thereof.

### Binder

The basecoat material and the clearcoat material of the multicoat paint systems of the invention may be physically curing.

For the purposes of the present invention the term “physical curing” denotes the curing of a layer of a coating composition by filming as a result of loss of solvent from the coating composition, with linking within the coating taking place via looping of the polymer molecules of the binders (regarding the term cf. Römpp Lexikon Lacke und Druckfarben, pages 73 and 74, entry heading “Bindemittel” [Binders]). Or else filming takes place by way of the coalescence of binder particles (cf. Römpp Lexikon Lacke und Druckfarben, pages 274 and 275, entry heading “Härtung” [Curing]). Typically no crosslinking agents are necessary for this purpose. Where appropriate, the physical curing may be assisted by atmospheric oxygen, by heat or by exposure to actinic radiation.

Basecoat and/or clearcoat materials may be thermally curable. This may involve self-crosslinking or external crosslinking.

For the purposes of the present invention the term “self-crosslinking” identifies the capacity of a binder to enter into crosslinking reactions with itself. A prerequisite for this is that the binders already include both kinds of complementary reactive functional groups which are needed for crosslinking, or else the binder contains reactive functional groups which are able to react “with themselves”. Externally crosslinking coating compositions, on the other hand, are those in which one kind of the complementary reactive functional groups is present in the binder, and the other kind is present in a crosslinking agent. For further details on this refer to Römpp Lexikon Lacke and Druckfarben, Georg Thieme Verlag, Stuttgart, New York, 1998, “Härtung” [Curing], pages 274 to 276, especially page 275, bottom.

Suitable binders are the binders typically employed in basecoat and clearcoat materials in the automobile industry sector, with the selection of the nature and amount of the synthesis components employed in preparing these binders being used, in a manner familiar to the skilled worker, to control the properties and hence the suitability of the binders for basecoat and clearcoat material.

It is preferred to employ binders containing thio, hydroxyl, N-methylolamino, N-alkoxymethylamino, imino, carbamate, allophanate and/or carboxyl groups, preferably hydroxyl or carboxyl groups, on the one hand, and to employ crosslinking agents containing anhydride, carboxyl, epoxy, blocked isocyanate, urethane, methylol, methylol ether, siloxane, carbonate, amino, hydroxyl and/or beta-hydroxyalkylamide groups, preferably epoxy, beta-hydroxyalkylamide, blocked and nonblocked isocyanate, urethane or alkoxymethylamino groups, on the other.

In the case of self-crosslinking coating materials, the binders contain more particularly methylol, methylol ether and/or N-alkoxymethylamino groups.

Complementary reactive functional groups which are especially suitable for use in the coating materials of the multicoat paint system of the invention are hydroxyl groups on the one hand and blocked and nonblocked isocyanate, urethane or alkoxymethylamino groups on the other.

The functionality of the binders with respect to the above-described reactive functional groups may vary very widely and is guided in particular by the target crosslinking density and/or by the functionality of the crosslinking agents employed in each case. In the case of hydroxyl-containing binders, for example, the OH number is preferably 15 to 300, more preferably 20 to 250, with particular preference 25 to 200, very preferably 30 to 150, and in particular 35 to 120 mg KOH/g in accordance with DIN 53240.

The above-described complementary functional groups can be incorporated into the binders in accordance with the customary and known methods of polymer chemistry. This can be done, for example, by the incorporation of monomers which carry corresponding reactive functional groups, and/or by means of polymer-analogous reactions.

Suitable binders generally have a number-average molecular weight of 400 to 5000 g/mol. The molecular weight is determined by means of GPC analysis with THF (+0.1% of acetic acid) as eluent (1 ml/min) on a styrene-divinylbenzene column combination. Calibration is carried out with polystyrene standards.

The binders are used preferably in an amount of 15% to 50% by weight, more preferably of 20% to 40% by weight, based in each case on the total weight of the basecoat or clearcoat material.

Examples of suitable binders include random, alternating and/or block, linear and/or branched and/or comb (co)polymers of ethylenically unsaturated monomers, or polyaddition resins and/or polycondensation resins. For further details of these terms refer to Römpp Lexikon Lacke and Druckfarben, page 457, entry headings “Polyaddition” and “Polyadditionsharze (Polyaddukte)” [Polyaddition resins (polyadducts)], and also pages 463 and 464, entry headings “Polykondensate” [Polycondensates], “Polykondensation” [Polycondensation], and “Polykondensationsharze” [Polycondensation resins], and also pages 73 and 74, entry heading “Bindemittel” [Binders].

Examples of suitable (co)polymers are (meth)acrylate (co)polymers or partially hydrolyzed polyvinyl esters, especially (meth)acrylate copolymers. The term (meth)acrylate embraces both acrylate and methacrylate.

Examples of suitable polyaddition resins and/or polycondensation resins are polyesters, alkyds, polyurethanes, polylactones, polycarbonates, polyethers, epoxy resin-amine adducts, polyureas, polyamides, polyimides, polyester-polyurethanes, polyether-polyurethanes or polyester-polyether-polyurethanes, especially polyesters.

Of these binders the (meth)acrylate (co)polymers and the polyesters, especially the (meth)acrylate (co)polymers, have particular advantages and are therefore used with particular preference.

Suitable polyester resins may be saturated or unsaturated, especially saturated, and are described for example in EP-B-787 159, page 4 lines 26 to 53.

Suitable acrylate resins may be prepared by methods known to the skilled worker, using olefinically unsaturated monomers containing reactive functional groups, where appropriate in combination with monomers without reactive functional groups.

Examples of suitable olefinically unsaturated monomers containing reactive functional groups are as follows:

a) monomers which carry at least one hydroxyl, amino, alkoxymethylamino, carbamate, allophanate or imino group per molecule, such as
hydroxyalkyl esters of acrylic acid, methacrylic acid or another alpha,beta-olefinically unsaturated carboxylic acid that derive from an alkylene glycol which is esterified with the acid, or that are obtainable by reacting the alpha,beta-olefinically unsaturated carboxylic acid with an alkylene oxide such as ethylene oxide or propylene oxide, especially hydroxyalkyl esters of acrylic acid, methacrylic acid, ethacrylic acid, crotonic acid, maleic acid, fumaric acid or itaconic acid, in which the hydroxyalkyl group contains up to 20 carbon atoms, such as 2-hydroxyethyl, 2-hydroxypropyl, 3-hydroxypropyl, 3-hydroxybutyl, 4-hydroxybutyl acrylate, methacrylate, ethacrylate, crotonate, maleate, fumarate or itaconate; or hydroxycycloalkyl esters such as 1,4-bis(hydroxymethyl)cyclohexane, octahydro-4,7-methano-1H-indenedimethanol or methylpropanediol monoacrylate, monomethacrylate, monoethacrylate, monocrotonate, monomaleate, monofumarate or monoitaconate; reaction products of cyclic esters, such as epsilon-caprolactone, for example, and these hydroxyalkyl or cycloalkyl esters;
olefinically unsaturated alcohols such as allyl alcohol;
polyols such as trimethylolpropane monoallyl or diallyl ether or pentaerythritol monoallyl, diallyl or triallyl ether;
reaction products of acrylic acid and/or methacrylic acid with the glycidyl ester of an alpha-branched monocarboxylic acid having 5 to 18 C atoms per molecule, more particularly of a Versatic® acid, or, instead of the reaction product, an equivalent amount of acrylic and/or methacrylic acid, which is then reacted, during or after the polymerization reaction, with the glycidyl ester of an alpha-branched monocarboxylic acid having 5 to 18 C atoms per molecule, more particularly a Versatic® acid;
aminoethyl acrylate, aminoethyl methacrylate, allylamine or N-methylimino-ethyl acrylate;
N,N-di(methoxymethyl)aminoethyl acrylate or methacrylate or N,N-di(butoxymethyl)aminopropyl acrylate or methacrylate;
(meth)acrylamides, such as (meth)acrylamide, N-methyl-, N-methylol-, N,N-dimethylol-, N-methoxymethyl-, N,N-di(methoxymethyl)-, N-ethoxymethyl- and/or N,N-di(ethoxyethyl)-(meth)acrylamide;
acryloyloxy- or methacryloyloxyethyl, -propyl or -butyl carbamate or allophanate; further examples of suitable monomers containing carbamate groups are described in patent publications U.S. Pat. Nos. 3,479,328, 3,674,838, 4,126,747, 4,279,833 or U.S. Pat. No. 4,340,497.

b) monomers which carry at least one acid group per molecule, such as
acrylic acid, beta-carboxyethyl acrylate, methacrylic acid, ethacrylic acid, crotonic acid, maleic acid, fumaric acid or itaconic acid;
olefinically unsaturated sulfonic or phosphonic acids or their partial esters;
mono (meth)acryloyloxyethyl maleate, succinate or phthalate; or
vinylbenzoic acid (all isomers), alpha-methylvinylbenzoic acid (all isomers) or vinylbenzenesulfonic acid (all isomers).

c) Monomers containing epoxide groups, such as the glycidyl ester of acrylic acid, methacrylic acid, ethacrylic acid, crotonic acid, maleic acid, fumaric acid or itaconic acid, or allyl glycidyl ether.

Monomers of the above-described kind that are of higher functionality are generally used in minor amounts. For the purposes of the present invention, minor amounts of monomers of relatively high functionality mean those amounts which do not lead to crosslinking or gelling of the copolymers, particularly of the (meth)acrylate copolymers.

Examples of suitable olefinically unsaturated monomers without reactive functional groups include alkyl esters of acrylic acid, methacrylic acid or another alpha,beta-olefinically unsaturated carboxylic acid, vinylaromatic compounds, and mixtures of these monomers.

Also suitable as binders are polyurethane resins. The polyurethane resins are obtained in a manner known to the skilled worker by reacting
at least one polyol selected from the group consisting of polyester polyols and polyether polyols, preferably having a number-average molecular weight of 400 to 5000, and
at least one polyisocyanate, and also
if desired, at least one compound containing at least one isocyanate-reactive functional group and at least one (potentially) anionic group in the molecule,
if desired, at least one further compound containing at least one isocyanate-reactive functional group, and
if desired, at least one compound with a number-average molecular weight of 60 to 600 daltons, containing hydroxyl and/or amino groups in the molecule.

Polyurethane resins of this kind are described for example in European patent applications EP 228003 and EP 574417.

Polyurethane resins of this kind are obtained for example by using, as the isocyanate component, isocyanates that are typically employed in the paint industry sector, such as, for example, hexamethylene diisocyanate, octamethylene diisocyanate, decamethylene diisocyanate, dodecamethylene diisocyanate, tetradecamethylene diisocyanate, trimethylhexane diisocyanate, tetramethylhexane diisocyanate, isophorone diisocyanate, 2-isocyanatopropylcyclohexyl isocyanate, dicyclohexylmethane 2,4′-diisocyanate, dicyclohexylmethane 4,4′-diisocyanate, 1,4- or 1,3-bis(isocyanatomethyl)cyclohexane, 1,4- or 1,3- or 1,2-diisocyanatocyclohexane, 2,4- or 2,6-diisocyanato-1-methylcyclohexane, diisocyanates derived from dimer fatty acids, as sold under the name DDI 1410 by Henkel, 1,8-diisocyanato-4-isocyanatomethyloctane, 1,7-diisocyanato-4-isocyanatomethylheptane or 1-isocyanato-2-(3-isocyanatopropyl)cyclohexane, or tetramethylxylylene diisocyanates (TMXDI) or mixtures of these polyisocyanates, preferably tetramethylxylylene diisocyanate (TMXDI) and/or isophorone diisocyanate, preferably isophorone diisocyanate.

As chain extenders with hydroxyl and/or amino groups it is preferred to use trimethylolpropane and diethanolamine.

Together with or instead of the stated polyurethane resins, other suitable binders in the basecoat materials are those known as acrylated polyurethane resins, which are obtainable in a manner known to the skilled worker by polymerizing ethylenically unsaturated monomers in the presence of a polyurethane resin. In this case it is possible to use polyurethane resins without double bonds and/or polyurethane resins with double bonds.

As binders it is also possible to use acrylated polyurethane resins having pendant and/or terminal double bonds, especially those with pendant and/or terminal ethenylarylene groups.

The acrylated polyurethane resins with pendant and/or terminal double bonds may be obtained by reacting a polyurethane prepolymer (1-1) which contains at least one free isocyanate group with a compound (1-2) which has at least one ethylenically unsaturated double bond and one NCO-reactive group, more particularly a hydroxyl group or an amino group.

The acrylated polyurethane resins with pendant and/or terminal double bonds may also be obtained by reacting a polyurethane prepolymer (11-1) which contains at least one NCO-reactive group, more particularly at least one hydroxyl group or one amino group, with a compound (11-2) which has at least one ethylenically unsaturated double bond and one free isocyanate group.

Also used as binders are graft copolymers which are obtainable by polymerizing olefinically unsaturated monomers in the presence of the acrylated polyurethane resins with pendant and/or terminal double bonds.

Use is made in particular of graft copolymers which comprise a hydrophobic core of at least one copolymerized olefinically unsaturated monomer and a hydrophilic shell of at least one hydrophilic acrylated polyurethane. Also suitable, however, are graft copolymers which comprise a hydrophobic core of at least one hydrophobic acrylated polyurethane and a hydrophilic shell of at least one copolymerized olefinically unsaturated monomer.

Suitable acrylated polyurethane resins and also graft copolymers prepared from them are described in, for example, WO01/25307, page 5 line 14 to page 45 line 4, and EP-B-787 159, page 2 line 27 to page 7 line 13.

The polyurethane resins described can be used where appropriate in combination with one or more polyacrylate resins and/or with one or more polyester resins.

### Crosslinking Agent

The amount of crosslinking agent in the basecoat or clearcoat material of the multicoat paint system of the invention, based in each case on the total weight of the respective coating material, is preferably 5% to 30% by weight and more preferably 7% to 20% by weight.

As crosslinking agents, used where appropriate, the basecoat materials may comprise free isocyanates or blocked isocyanates and/or amino resins.

Suitable isocyanate in this context encompasses in principle the isocyanates specified in connection with the description of the polyurethane resins suitable as binders and used typically in the paint industry sector, preferably TACT and dimethylpyrazole-blocked trimeric hexamethylene diisocyanate and also, in the case of two-component coating compositions, trimeric hexamethylene diisocyanate.

Suitable blocking agents include all typically employed blocking agents, such as the corresponding alcohols, amines, ketones, pyrazoles, etc., preferably blocking agents having a deblocking temperature of less than 130° C.

Suitable in principle are the amino resins that are typically employed in the paint industry sector, it being possible to control the properties of the basecoat materials via the reactivity of the amino resins. Preference is given to using methanol- and/or butanol-etherified amino resins, examples being the products available commercially under the names Cymel®, Resimene®, Maprenal®, and Luwipal®, especially Resimene® 747 and Resimene® 755.

### Colorants

The basecoat materials comprise at least one colorant. “Colorant” is the generic term for all color-imparting substances. In accordance with DIN 55944: 1990-04 they can be divided, according to their solubility in the surrounding medium, into dyes and pigments. Dyes are organic, black or chromatic substances which are soluble in the surrounding medium (cf. Römpp Lacke und Druckfarben, pagee 221, entry heading “Farbmittel” [Colorants]). Pigments, in contrast, are colorants in powder or platelet form which, unlike dyes, are insoluble in the surrounding medium (cf. Römpp Lacke und Druckfarben, page 451, entry heading “Pigmente” [Pigments]).

The colorant is preferably a pigment. The pigment is preferably selected from the group consisting of organic and inorganic, color-imparting, effect-imparting, color- and effect-imparting, magnetically shielding, electrically conductive, corrosion-inhibiting, fluorescent, and phosphorescent pigments. Preference is given to using the color- and/or effect-imparting pigments (color and/or effect pigments).

With particular preference the basecoat material comprises at least one effect pigment, more particularly at least one metal flake pigment. Together with the effect pigment or pigments, the basecoat material may further comprise at least one, or two or more, color pigment(s).

Examples of suitable effect pigments, which may also impart color, are metal flake pigments, such as commercial aluminum bronzes and commercial stainless steel bronzes, and also nonmetallic effect pigments, such as, for example, pearlescent pigments and interference pigments, platelet-shaped effect pigments based on iron oxide, or liquid-crystalline effect pigments. For further details refer to Römpp Lexikon Lacke und Druckfarben, page 176, entry heading “Effektpigmente” [Effect pigments] and pages 380 and 381, entry headings “Metalloxid-Glimmer-Pigmente” [Metal oxide-mica pigments] to “Metallpigmente” [Metallic pigments].

Commercial aluminum bronzes are used in particular. Use is made both of untreated types, which are available commercially, for example, under the name Stapa® Metallux from Eckart, and of treated types, especially silanized types, which are described, for example, in WO 01/81483 and are available commercially, for example, under the name Hydrolan® from Eckart.

The metal flake pigment preferably has a thickness of 200 to 2000 nm and more particularly 500 to 1500 nm.

The metal flake pigment preferably has an average particle size of 10 to 50 and more particularly of 13 to 25 μm (ISO 13320-1 by Cilas (instrument 1064)).

Suitable organic and/or inorganic color pigments are the pigments that are typically employed in the paint industry. Use may also be made, furthermore, of the dyes typically employed in the paint industry.

Examples of suitable inorganic color pigments are white pigments such as titanium dioxide, zinc white, zinc sulfide or lithopones; black pigments such as carbon black, iron manganese black or spinel black; chromatic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chromium orange; or yellow iron oxide, nickel titanium yellow, chromium titanium yellow, cadmium sulfide, cadmium zinc sulfide, chromium yellow or bismuth vanadate.

Examples of suitable organic color pigments are monoazo pigments, disazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments or aniline black.

For further details refer to Römpp Lexikon Lacke and Druckfarben, Georg Thieme Verlag, 1998, pages 180 and 181, entry headings “Eisenblau-Pigmente” [Iron blue pigments] to “Eisenoxidschwarz” [Black iron oxide], pages 451 to 453, entry headings “Pigmente” [Pigments] to “Pigmentvolumenkonzentration” [Pigment volume concentration], page 563, entry heading “Thioindigo-Pigmente” [Thioindigo pigments], page 567, entry heading “Titandioxid-Pigmente” [Titanium dioxide pigments], pages 400 and 467, entry heading “Natürlich vorkommende Pigmente” [Naturally occurring pigments], page 459, entry heading “Polycyclische Pigmente” [Polycyclic pigments], page 52, entry headings “Azomethinpigmente” [Azomethine pigments], and “Azopigmente” [Azo pigments], and page 379, entry heading “Metallkomplex-Pigmente” [Metal complex pigments].

The amount of the pigments may vary very widely and is guided primarily by the depth of the color and/or the intensity of the effect that are to be established, and also by the dispersibility of the pigments in basecoat materials. In the case of solid-color coating materials, based in each case on the total weight of the basecoat material, the pigment content is preferably 1% to 49% by weight. In the case of metallic coating materials, again based in each case on the total weight of the basecoat material, the pigment content is preferably 0.5% to 40%, more preferably 0.5% to 35%, and very preferably 1% to 30% by weight.

### Organic Solvents

The amount of solvent in the basecoat material of the multicoat paint system of the invention, based in each case on the total weight of the basecoat material, is preferably 30% to 65%, more preferably 30% to 62%, and very preferably 30% to 60% by weight.

Preferred basecoat materials have a viscosity at 23° C. of 16 s to 35 s and more preferably 18 to 25 s as the flow time from the Ford 3 cup. The solids content is at least 35%, preferably at least 38%, and more preferably at least 40% by weight.

The amount of solvent in the clearcoat material of the multicoat paint system of the invention, based in each case on the total weight of the clearcoat material, is preferably 30% to 50%, more preferably 30% to 48% by weight.

Preferred clearcoat materials have a viscosity at 23° C. of 40 s to 60 s, more preferably 45 to 50 s, as the flow time from the Ford 3 cup. The solids content is at least 50% and more preferably at least 52% by weight.

Suitable solvents are all of the solvents that are typically used in the paint industry, examples being alcohols, glycol ethers, esters, ether esters, and ketones, aliphatic and/or aromatic hydrocarbons, such as, for example, acetone, methyl isobutyl ketone, methyl ethyl ketone, butyl acetate, 3-butoxy-2-propanol, ethyl ethoxy-propionate, butylglycol, butylglycol acetate, butanol, dipropylene glycol methyl ether, butyl glycolate, xylene, toluene, Shellsol® T, Pine Oel 90/95, Solventnaphtha®, Shellsol® A, Solvesso, benzine 135/180, and so on.

The coating compositions (basecoat material and clearcoat material) are nonaqueous.

### Auxiliaries and Additives

Besides the above-described components, basecoat and/or clearcoat materials may comprise customary and known auxiliaries and additives in typical amounts, preferably 0.05% to 40% and more preferably 0.5% to 30% by weight, based on the total weight of the respective coating material.

Examples of suitable auxiliaries and additives are organic and inorganic fillers, such as talc, and/or further customary auxiliaries and additives, such as antioxidants, deaerating agents, wetting agents, dispersants, emulsifiers, rheological assistants such as flow control agents, thickeners, antisag agents, and thixotropic agents, waxes, slip additives, reactive diluents, free-flow aids, siccatives, biocides, additives for enhancing substrate wetting, additives for enhancing surface smoothness, matting (or flatting) agents, free-radical scavengers, light stabilizers, preferably the above-described UV absorbers with an absorption maximum below 370 nm and/or HALS, corrosion inhibitors, flame retardants or polymerization inhibitors, as are described in the book “Lackadditive” [Additives for Coatings] by Johan Bieleman, Wiley-VCH, Weinheim, New York, 1998, in detail. Preferred auxiliaries and additives are rheological assistants, deaerating agents, wetting agents, dispersants, UV absorbers, and free-radical scavengers. Particularly preferred auxiliaries and additives are UV absorbers and wetting agents.

The basecoat material of the multicoat paint system of the invention preferably includes as an additive at least one constituent selected from the group consisting of polymer microparticles, stabilized inorganic particles, waxes, and waxlike compounds.

### Polymer Microparticles (M)

In basecoat materials of the multicoat paint system of the invention it is advantageous to use polymer microparticles. Suitable polymer microparticles are described in, for example, EP-A-480 959, page 3 line 36 to page 4 line 35, WO 96/24619, WO 99/42529, EP-B-1 173 491, EP-B-1 185 568, WO 03/089487, WO 03/089477, WO 01/72909 and WO 99/42531. The polymer microparticles may be used in particular to control the flow, the evaporation behavior, and the attitude toward incipient dissolution by the clearcoat material.

Suitable polymer microparticles typically have a number-average molecular weight of 2000 to 100 000. The molecular weight is determined by means of GPC analysis with THF (+0.1% of acetic acid) as eluent (1 ml/min) on a styrene-divinylbenzene column combination. Calibration is carried out with polystyrene standards.

Suitable polymer microparticles also typically have an average particle size of 0.01 to 10 μm, in particular of 0.01 to 5 μm, and very preferably of 0.02 to 2 μm, in accordance with ISO 13320-1.

Polymer microparticles used with particular preference contain reactive functional groups which are able to react with the functional groups of the crosslinking agent. In particular the polymer microparticles contain hydroxyl groups. In this case the polymer microparticles preferably have a hydroxyl number of 5 to 150 mg KOH/g in accordance with DIN 53240. Hydroxyl-containing polymer microparticles are described in WO 01/72909, for example.

Crosslinked polymer microparticles are obtainable by, for example, subjecting a mixture of:

(a) an ethylenically unsaturated monomer which contains one ethylenically unsaturated group per molecule, or a mixture of such monomers, and

(b) an ethylenically unsaturated monomer which contains at least two ethylenically unsaturated groups per molecule, or a mixture of such monomers,

to polymerization in an aqueous phase in the presence, if desired, of emulsifiers or in the presence, if desired, of a carrier resin, and then transferring the aqueous polymer microparticle dispersion obtained in this way into an organic solvent or a mixture of organic solvents.

Preference is given to polymer microparticles which have been prepared using components containing ionic and/or polar groups, preferably hydroxyl groups and/or carboxyl groups. The components (a) and (b) ought in general to contain between 1% and 20%, preferably between 3% and 15%, by weight of ionic and/or polar groups.

In order to obtain sufficiently crosslinked polymer microparticles it is generally sufficient to use 0.25 to 1.2 mol, preferably 0.3 to 1 mol, of component (b) per mole of component (a).

Alternatively the polymer microparticles (M) used in the basecoat materials may be prepared directly in organic phase.

Polymer microparticles used with preference are obtainable, for example, by subjecting a mixture of:

(c) an ethylenically unsaturated monomer (M1) which contains at least one reactive group (G1) per molecule, or a mixture of such monomers (M1), and

(d) if desired, an ethylenically unsaturated monomer (M2) which contains at least one non-(G1) reactive group (G2) per molecule, or a mixture of such monomers (M2), and

(e) if desired, a further ethylenically unsaturated monomer (M3) or a mixture of such monomers (M3)

to polymerization in an organic solvent in the presence, if desired, of a carrier resin.

Examples of suitable monomers (M1) are monomers which contain hydroxyl groups, carbamate groups, amino groups, alkoxymethylamino groups, allophanate groups or imino groups, especially hydroxyl groups.

The monomers (M1) with the reactive groups (G1) here may also be prepared by reacting two compounds of which one compound (a) contains a reactive group (a) and at least one ethylenically unsaturated double bond, and the other compound contains an ethylenically unsaturated double bond.

Examples of suitable monomers (M2) are monomers which contain carboxyl groups.

Suitable monomers (M3) are the so-called neutral monomers that are typically employed, i.e., ethylenically unsaturated monomers which contain no reactive groups.

The polymer microparticles (M) are used in the basecoat materials of the multicoat paint system of the invention typically in an amount of 3% to 30% by weight, more particularly of 10% to 25% by weight, based in each case on the total weight of the basecoat material.

### Inorganic Particles (N)

The basecoat material of the multicoat paint system of the invention may comprise one or more inorganic particles (N) with a particle size of 1 to 800 nm, preferably of 3 to 250 nm, more preferably of 4 to 100 nm. This particle size refers to the size of the dispersed particles (N) prior to incorporation into the basecoat material. Particle size may be determined by means of electron microscopy, for example.

Suitable inorganic particles (N) are described in WO 2008/058590, for example.

The inorganic particles (N) preferably have a primary particle size of 3 to 200 nm, more particularly of 3 to 30 nm. In contrast to the above-described colorants (color-imparting substances), the inorganic particles (N) used in the basecoat materials are typically substantially colorless, in particular so as not to affect the hue of the basecoat material.

The inorganic particles (N) may be present in the form of separate particles or in the form of agglomerates, though it is preferred to use separate particles. In particular the inorganic particles (N) ought especially to be easily and stably incorporable into the basecoat material, in order to ensure the desired utility of the basecoat material. The inorganic particles (N) ought therefore either to remain stably dispersed for a long time (in the automotive finishing sector, for example, over a period of up to 12 months on storage at temperatures of up to 30° C.) or else to be readily redispersible with typical means of paint mixing, such as using stirrers, for example.

It is preferred to use inorganic particles (N) which have a density of 0.8 to 4.5 g/cm³ in accordance with DIN 53217.

The inorganic particles (N) are typically selected from the group consisting of the compounds of the main-group and transition-group metals, preferably of the metals from main groups three to five, transition groups three to six and also one and two of the periodic table of the elements, and also the lanthanides, more particularly compounds of boron, aluminum, gallium, silicon, barium, germanium, tin, arsenic, antimony, silver, zinc, titanium, zirconium, hafnium, vanadium, niobium, tantalum, molybdenum, tungsten, and cerium, especially aluminum, silicon, barium, silver, cerium, titanium, and zirconium.

The compounds of the metals are preferably the oxides, oxide hydrates, sulfates or phosphates. Suitable inorganic particles (N) are preferably selected from the group consisting of hydrophilic and hydrophobic, especially hydrophilic, particles based on silicon dioxide, aluminum oxide, zinc oxide, zirconium oxide, barium sulfate, and the polyacids and heteropolyacids of transition metals, preferably of molybdenum and tungsten. Particular preference is given to using particles based on silicon dioxide and/or aluminum oxide, more particularly fumed or colloidal silicon dioxide.

Very particular preference is given to using hydrophilic fumed silicon dioxides whose agglomerates and aggregates have a catenary structure, preparable by the flame hydrolysis of silicon tetrachloride in an oxyhydrogen flame. These silicas are sold by the company Degussa under the brand name Aerosil®, for example.

Also useful as inorganic particles (N), however, are sols, especially organosols. Sols of this kind are described for example in U.S. Pat. No. 4,522,958, column 7 line 26 to column 11 line 14. Particular mention is made here of silica-based sols in which the inorganic particles are formed in situ and are modified, during and/or after their formation, with a stabilizer (S) (and are known as stabilized inorganic particles). These particles may be prepared by means of a multiplicity of different techniques known to the skilled worker.

It is advantageous to incorporate the inorganic particles (N) in the form of pastes. Further advantages result if the pasting resins or grinding resins used are the binders already described that are present in the basecoat material. As paste resins or grinding resins for the particles (N) use is made in particular of binders which are also used for dispersing the pigments.

The particles (N) are used preferably in an amount of 0.2% to 2% by weight, more preferably of 0.5% to 1.5% by weight, based in each case on the total weight of the basecoat material.

### Stabilizer (S)

The inorganic particles (N) are at least partly modified with a stabilizer (S) which comprises at least one group (S1) which is able to interact with the surface of the inorganic particles (N), and one or more hydrophobic substructures.

Suitable stabilizers (S) are described in WO 2008/058590, for example.

The stabilizer (S) may interact with the inorganic particles (N) via the groups (S1). In that case it is possible for the stabilizer to interact with the inorganic particles only by way of physical forces, although it is also possible for there to be, at least in part, a chemical reaction between the groups (S1) and the functional groups that are customarily located on the surface of the inorganic particles. Thus, in particular, the hydrophilic inorganic particles have hydroxyl groups on their surface (in the form of SiOH groups in the case of the SiO₂ types, for example), which are able to interact not only chemically but also physically, such as in the form of hydrogen bonds, for example, with the groups (S1).

The groups (S1) of stabilizer are preferably selected from the group of hydroxyl, carboxyl, ether, phosphate, phosphonate, bisphosphonate, sulfate or sulfonate groups or nitrogen-containing hydrophilic groups or mixtures thereof. Particularly preferred stabilizers (S) are those containing not only hydroxyl groups but also carboxyl groups. Particular preference is also given to stabilizers (S) which contain not only hydroxyl groups but also carboxyl groups and ether groups. Use is made in particular of stabilizers (S) which have a hydroxyl number of 10 to 150 mg KOH/g in accordance with DIN 53240 and an acid number of 2 to 50 mg KOH/g in accordance with DIN EN ISO 3682, based in each case on the solids of the stabilizer (S).

The stabilizer (S) may further comprise one or more hydrophobic substructures. These hydrophobic radicals can interact with the organic constituents of the basecoat material, in particular with the solvent, the binders, and the wax and/or waxlike compound (W).

The stabilizer (S) may therefore contain, in particular, one or more organic radicals (R1) which comprise the hydrophobic substructures. Furthermore, the organic radical or radicals (R1) may where appropriate also contain hydrophilic substructures and/or the groups (S1) may be attached at least partly, or completely, to these organic radicals (R1).

It is preferred for the hydrophobic substructures of the stabilizer (S) to be selected at least in part from the group of alkyl or alkenyl groups, especially alkyl or alkenyl groups having 5 to 50 C atoms.

Particularly preferred hydrophobic substructures used are the radicals of saturated and/or unsaturated fatty acids, especially of saturated and/or unsaturated fatty acids having 5 to 30 carbon atoms in the molecule, such as, for example, radicals of valeric acid, caproic acid, enanthic acid, caprylic acid, pelargonic acid, capric acid, undecylic acid, lauric acid, myristic acid, palmitic acid, stearic acid, oleic acid, elaidic acid, arachidic acid, behenic acid, linoceric acid, cerotinic acid, melissic acid, linoleic acid, ricinene acid, ricinoleic acid, linolenic acid, arachidonic acid, clupanodonic acid, alpha-eleostearic acid, alpha-licanic acid, alpha-parinaric acid, ricinoleic acid, and isanolic acid, and mixtures of these fatty acids, and/or the corresponding hydroxy acids of the stated fatty acids, or mixtures thereof. Very particular preference is given to using stabilizers which comprise radicals of hydroxyvaleric acid, hydroxycaproic acid, hydroxystearic acid, hydroxylauric acid, ricinoleic acid or mixtures thereof.

Also suitable, furthermore, are the corresponding radicals of dimer and trimer fatty acids and also their mixtures, and the radicals of the corresponding mixtures of the dimer and/or trimer fatty acids with the stated fatty acids.

It is very particularly preferred to make use as stabilizer (S) of esters of the stated (hydroxy) fatty acids, (hydroxy) dimer fatty acids and/or (hydroxy) trimer fatty acids, particularly esters with polyalkylene glycols, more preferably esters with polyalkylene glycols having 6 to 20 C atoms, such as diethylene glycol, triethylene glycol, tetraethylene glycol, dipropylene glycol, tripropylene glycol, and mixtures thereof. Here, mention is made in particular of esters of hydroxyvaleric acid, hydroxycaproic acid, and hydroxystearic acid with triethylene glycol, tetraethylene glycol, and mixtures of these hydroxyl compounds, these esters, and mixtures of the esters with the acids.

Also suitable as stabilizer (S), for example, are the corresponding commercial compounds, provided they have the requisite structure. Suitability is therefore possessed, for example, by those in commerce under the names Solsperse® from Avecia GmbH, especially Solsperse® 39000, Dispers® from Th. Goldschmidt, especially Dispers® 652, and corresponding additives from Degussa.

The stabilizer (S) is used typically in an amount of 3% to 40%, in particular of 5% to 20%, very preferably of 8% to 12%, by weight, based in each case on the weight of the inorganic particles (N) employed.

One of the assurances provided by the modification of the inorganic particles (N) with the stabilizer (S) is that even on storage at 40° C. for 28 days there will be no significant deterioration in the properties either of the basecoat materials or of the coatings produced from these stored basecoat materials; in particular, there will be no deterioration in the rheological properties of the basecoat materials, and no impairment to the flop of the resultant coatings.

### Wax and Waxlike Compound (W)

The basecoat material of the multicoat paint system of the invention may further comprise one or more waxes and/or one or more waxlike compounds. “(W)” embraces both waxes and waxlike compounds.

Suitable waxes and waxlike compounds are described in WO 2008/058590, for example.

In connection with the present invention, the terms “wax” and “waxlike compound” refer to all natural and synthetically obtained substances which have the following properties:

1. Kneadable or solid at 20° C.

2. Coarsely to finely crystalline, translucent to opaque.

3. Melting at above 40° C. without decomposition.

4. Of low viscosity even a little above the melting point.

5. Highly temperature-dependent in consistency and solubility.

6. Can be polished under gentle pressure.

If a substance fails to exhibit more than one of these properties, it is no longer a “wax” for the purposes of this invention (cf. Ullmanns Enzyklopädie der technischen Chemie; 4^{th}, revised and expanded edition; Verlag Chemie; Weinheim; Deerfield Beach, Fla.; Basel, 1983, page 3).

The waxes or waxlike compounds (W) may be modified and/or unmodified. All waxes that are customary and known per se are suitable, though it is preferred to use synthetic waxes.

Examples of natural waxes are plant waxes, such as carnauba wax, candelilla wax, esparto wax, guaruma wax, japan wax, cork wax, montan wax, ouricury wax, rice germ oil wax, sugarcane wax, animal waxes, such as beeswax, uropygial gland oil, wool wax, shellac wax, spermacetae, and mineral waxes, such as ceresin and ozokerite.

Examples of chemically modified waxes are hydrogenated jojoba waxes, montan ester waxes, and Sasol waxes.

Also suitable, for example, are modified and unmodified polyolefin waxes, such as polyethylene and polypropylene waxes, polyethylene glycol waxes, and polyamide waxes. Also suitable, furthermore, are the polyacrylate polymers and polyacrylate copolymers which like wax exhibit a pronounced temperature dependence of the solubility in organic solvents.

The waxes or polyacrylate polymers and polyacrylate copolymers commonly have a number-average molecular weight between 300 and 20 000 g/mol, preferably between 1000 and 10 000 g/mol, and preferably have Ubbelohde drop points of between 70 and 180° C. The drop point is a characteristic of lubricants. It identifies the temperature at which a lubricant grease under standardized test conditions forms an elongating droplet. It is regulated under DIN ISO 2176.

The polyethylene waxes and polypropylene waxes are either homopolymers or copolymers having typically 0.5% to 40% by weight of comonomer units, which derive from saturated or unsaturated monocarboxylic acids or their amides or esters. Examples of such comonomer units include the radicals of acrylic acid, methacrylic acid, maleic acid, fumaric acid, acrylamide, stearic acid or stearamide, or vinyl acetate. The polyolefin waxes are available commercially under diverse designations.

Suitable polyamide waxes include all of the polyamide waxes that are typically employed in coating compositions, examples being polyamide waxes containing fatty acid, which are available commercially, for example, under the name Disparlon®.

Also suitable are waxlike polysiloxanes, such as polydimethylsiloxanes, polydiphenylsiloxanes, or modified silicones, e.g., polyester-, polyether-, and acrylate-modified silicones, for example.

The compound (W) is used preferably in an amount of 0.2% to 2% by weight, more preferably of 0.5% to 1.5% by weight, based in each case on the total weight of the basecoat material.

Advantageous basecoat materials are obtained in particular when the particles (N) and the compound or compounds (W) are used in amounts such that the total amount of inorganic particles (N) plus wax and/or waxlike compound (W) is from 0.4% to 4% by weight, more preferably from 1% to 3% by weight, based in each case on the total weight of the basecoat material.

Advantageously the total amount of inorganic particles (N) plus wax and/or waxlike compound (W) is tailored to the amount of color pigments minus the amount of metallic pigments. The smaller the amount of color pigments in the basecoat material, the higher the total amount of inorganic particles (N) plus wax and/or waxlike compound (W), since, generally speaking, the flop will become more important when the amount of color pigments is small. In the case of coating compositions which contain no metallic or effect pigments, and are known as solid-color basecoat materials, use is likewise made of the combination of inorganic particles (N) plus wax and/or waxlike compound (W), which in this case has more particularly a stabilizing effect; in this case, however, smaller overall amounts of inorganic particles (N) plus wax and/or waxlike compound (W) are generally sufficient.

The invention is illustrated below with reference to examples.

### EXAMPLES

### 1. Preparation of the Clearcoat Materials

### 1.1. Preparation of a Thixotropic Paste #1 (CC-T#1)

A laboratory mill with stirrer mechanism from Vollrath was charged with 730.0 g of grinding charge consisting of 326.0 parts by weight of a methacrylate copolymer containing hydroxyl and carbamate groups, 394.0 parts by weight of pentyl acetate, and 10.0 parts by weight of Degussa Aerosil® 805 (fumed silica from Degussa AG), together with 1100.0 parts by weight of quartz sand (grain size 0.7-1 mm), and this charge was dispersed with water cooling for 30 minutes. Thereafter the quartz sand was separated off.

### 1.2. Preparation of a Thixotropic Paste #2 (CC-T#2)

A laboratory mill with stirrer mechanism from Vollrath was charged with 730.0 g of grinding charge consisting of 326.0 parts by weight of a methacrylate copolymer containing hydroxyl and carbamate groups, 394.0 parts by weight of pentyl acetate, and 10.0 parts by weight of Cab-o-Sil™ TS610 (hydrophobic silica from Cabot Corp.), together with 1100.0 parts by weight of quartz sand (grain size 0.7-1 mm), and this charge was dispersed with water cooling for 30 minutes. Thereafter the quartz sand was separated off.

### 1.3. Preparation of the Millbase CC-V0 for the Clearcoat Materials of the Inventive Multicoat Paint System, and Comparative Clearcoat Materials

For the preparation of the clearcoat materials of the inventive multicoat paint systems, CC-V3 and CC-V6, and of the clearcoat materials of noninventive multicoat paint systems, CC-V1, CC-V2, CC-V4, and CC-V5, first a millbase CC-V0 was prepared by mixing and homogenizing of the following constituents:

153.0 parts by weight of a methacrylate copolymer containing hydroxyl and carbamate groups,

228.0 parts by weight of a carbamate functional acrylate,

16.0 parts by weight of an epoxy-acrylate binder,

88.0 parts by weight of a methacrylate copolymer,

100.0 parts by weight of a commercial SCA acrylate,

42.0 parts by weight of thixotropic paste #1 (CC-T#1) from preparation example 1.1.,

84.0 parts by weight of thixotropic paste #2 (CC-T#2) from preparation example 1.2.,

101.0 parts by weight of a commercial hexamethoxymethylmelamine resin,

22.0 parts by weight of isobutanol,

2.0 parts by weight of a commercial tin catalyst (dibutyltin diacetate),

3.0 parts by weight of octanoic acid,

0.4 part by weight of n-butyl phosphate,

2.0 parts by weight of a commercial additive for enhancing the thixotropy (52 percent strength solution of polyhydroxycarboxylic acid amides),

2.0 parts by weight of a commercial, silicone-free, polyester-based flow control additive,

2.0 parts by weight of a commercial, silicone-free deaerating agent (77 percent strength solution of a combination of vinyl ether copolymer and acrylate),

9.0 parts by weight of a commercial hydroxyphenyltriazine-based UV absorber,

5.0 parts by weight of a commercial sterically hindered amine (HALS),

20.6 parts by weight of pentyl acetate,

mixture of: 47.0 parts by weight of Solventnaphta™ 180/210, 8.0 parts by weight of a commercial UV absorber, and

40.0 parts by weight of butyldiglycol acetate.

1.3.1. Preparation of a Comparative One-Component Clearcoat Material CC-V1 (Comparative with Nonblocked DDBSA Catalyst)

To prepare the one-component clearcoat material CC-V1, 97.5 parts by weight of the millbase CC-V0 from preparation example 1.3. were admixed with 0.9 part by weight of a commercial nonblocked dodecylbenzenesulfonic acid (DDBSA) catalyst (Nacure® 5076 from King Industries, Inc.) and adjusted with 4.0 parts by weight of xylene at 23° C. to a spray viscosity of 48 sec in the Ford 3 flow cup. Thereafter the one-component clearcoat material CC-V1 had a solids content, based on the total weight of the clearcoat material, of 53.7% by weight (1 h/125° C.).

1.3.2. Preparation of a Comparative One-Component Clearcoat Material CC-V2 (Comparative with Amine-Blocked DDBSA Catalyst)

To prepare the one-component clearcoat material CC-V2, 97.5 parts by weight of the millbase CC-V0 from preparation example 1.3. were admixed with 2.5 parts by weight of a commercial amine-blocked dodecylbenzenesulfonic acid (DDBSA) catalyst (Nacure® 5225 from King Industries, Inc.) and adjusted with 5.0 parts by weight of xylene at 23° C. to a spray viscosity of 48 sec in the Ford 3 flow cup. Thereafter the one-component clearcoat material CC-V2 had a solids content, based on the total weight of the clearcoat material, of 53.4% by weight (1 h/125° C.).

1.3.3. Preparation of the One-Component Clearcoat Material CC-V3 (with Epoxy-Isocyanate-Blocked DDBSA Catalyst of Formula (II))

To prepare the one-component clearcoat material CC-V3, 97.5 parts by weight of the millbase CC-V0 from preparation example 1.3. were admixed with 2.5 parts by weight of a commercial epoxy-isocyanate-blocked dodecylbenzenesulfonic acid (DDBSA) catalyst (Nacure® 55414 from King Industries, Inc.) and adjusted with 4.0 parts by weight of xylene at 23° C. to a spray viscosity of 48 sec in the Ford 3 flow cup. Thereafter the inventively employable one-component clearcoat material CC-V3 had a solids content, based on the total weight of the clearcoat material, of 53.1% by weight (1 h/125° C.).

1.3.4. Preparation of a Comparative One-Component Clearcoat Material CC-V4 (Comparative with Nonblocked p-TSA Catalyst)

To prepare the one-component clearcoat material CC-V4, 97.5 parts by weight of the millbase CC-V0 from preparation example 1.3. were admixed with 1.6 parts by weight of a commercial nonblocked para-toluenesulfonic acid (p-TSA) catalyst (K-Cure® 1040 from King Industries, Inc.) and adjusted with 5.0 parts by weight of xylene at 23° C. to a spray viscosity of 48 sec in the Ford 3 flow cup. Thereafter the noninventive one-component clearcoat material CC-V4 had a solids content, based on the total weight of the clearcoat material, of 53.8% by weight (1 h/125° C.).

1.3.5. Preparation of a Comparative One-Component Clearcoat Material CC-V5 (Comparative with Amine-Blocked p-TSA Catalyst)

To prepare the one-component clearcoat material CC-V5, 97.5 parts by weight of the millbase CC-V0 from preparation example 1.3. were admixed with 2.5 parts by weight of a commercial amine-blocked para-toluenesulfonic acid (p-TSA) catalyst (Nacure® 2500 from King Industries, Inc.) and adjusted with 4.0 parts by weight of xylene at 23° C. to a spray viscosity of 48 sec in the Ford 3 flow cup. Thereafter the noninventive one-component clearcoat material CC-V5 had a solids content, based on the total weight of the clearcoat material, of 53.8% by weight (1 h/125° C.).

1.3.6. Preparation of the One-Component Clearcoat Material CC-V6 (with Epoxy-Blocked p-TSA Catalyst of Formula (I))

To prepare the one-component clearcoat material CC-V6, 97.5 parts by weight of the millbase CC-V0 from preparation example 1.3. were admixed with 2.5 parts by weight of a commercial epoxy-blocked para-toluenesulfonic acid (p-TSA) catalyst (Cycat® VXK 6357 from Cytec Surface Specialties) and adjusted with 5.0 parts by weight of xylene at 23° C. to a spray viscosity of 48 sec in the Ford 3 flow cup. Thereafter the inventively employable one-component clearcoat material CC-V6 had a solids content, based on the total weight of the clearcoat material, of 53.4% by weight (1 h/125° C.).

### 2. Preparation of the Basecoat Materials

### 2.1. Preparation of an Acrylate Binder (BC-B)

A reactor is charged with 13.2 parts by weight of Solvesso 100 and this initial charge is heated to 167° C. At a pressure in the reactor of 0.35 bar over a time of 4 hours, the reactor is fed simultaneously with a monomer mixture consisting of 2.1 parts by weight of acrylic acid, 10.8 parts by weight of hydroxyethyl acrylate, 11.5 parts by weight of 2-ethylhexyl acrylate, 11.5 parts by weight of butyl acrylate, and 14.3 parts by weight of styrene, and with an initiator mixture consisting of 0.7 part by weight of di-tert-butyl peroxide and 11.1 parts by weight of a solution of dicumyl peroxide in Solvesso 100 (50% strength). Subsequently the batch is maintained at the aforementioned temperature and pressure for one hour, before, over a period of one hour, 21.5 parts by weight of epsilon-caprolactone are added. The reaction mixture is cooled to 150° C. and held under a pressure of 0.35 bar for 1.5 hours. The reaction mixture is cooled and adjusted with 4.0 parts by weight of Solvesso 100 to a solids of 75% by weight, based on the total weight of the binder. The resulting acrylate resin has an acid number of 23 mg KOH/g and an OH number of 73 KOH/g, based in each case on the solids.

### 2.2. Preparation of a Carrier Resin (BC-1)

A reactor is charged with 5.8 parts by weight of xylene, 5.8 parts by weight of toluene, and 0.2 part by weight of methanesulfonic acid, and this initial charge is heated to 104° C. Subsequently 80.6 parts by weight of 12-hydroxystearic acid are supplied to the reactor and the batch is boiled under reflux at 171° C. with removal of the water of reaction. When an acid number of 35 is reached, based on the 130° C. solids content, the reaction is at an end. After cooling, the solids is adjusted with 8.0 parts by weight of solvent naphtha to 80.0 parts by weight, based on the total weight of the carrier resin solution.

### 2.3. Preparation of Polymer Microparticles (BC-M)

A reactor is charged with 43.2 parts by weight of solvent naphtha, 0.08 part by weight of N,N-dimethylcocosamine, and 1.0 part by weight of ethyl acetate, and this initial charge is heated to 104° C. At a pressure in the reactor of 0.69 bar over the course of 2 hours, the reactor is admixed simultaneously with a monomer mixture consisting of 27.6 parts by weight of methyl methacrylate, 3.8 parts by weight of 2-hydroxypropyl methacrylate, 0.8 part by weight of glycidyl methacrylate, 12.8 parts by weight of the above-described carrier resin (BC-1), 1.5 parts by weight of methacrylic acid, and 1.5 parts by weight of octyl mercaptan, and with an initiator mixture consisting of 2.3 parts by weight of tert-butyl peroxy-2-ethylhexanoate and 5.1 parts by weight of solvent naphtha. Subsequently the batch is held at the abovementioned temperature and pressure for 3 hours, and then cooled, and adjusted with 7.5 parts by weight of solvent naphtha to a solids of 41.0%, based on the total weight of the polymer microparticle solution.

### 2.4. Preparation of the Inorganic Particles, Stabilized (BC-N)

In a receiver vessel, 10.0 parts by weight of the acrylate binder described under 2.1, 6.0 parts by weight of Degussa Aerosil® 380 (commercial hydrophilic fumed silica from Degussa AG with a specific surface area (BET) of 380 m²/g, an average primary particle size of 7 nm, and an SiO₂ content of at least 99.8% by weight, based on the calcined substance), 41.7 parts by weight of solvent naphtha, 41.7 parts by weight of butyl acetate, and 0.6 part by weight of a fatty acid ester as stabilizer (S), with a nonvolatile fraction of 96.2% at 2 hours and 130° C., based on the total weight of the stabilizer, an OH number of 50 mg KOH/g, and an acid number of 17.2 mg KOH/g, based in each case on the 130° C. solids content, containing 6-hydroxycaproic acid, hydroxyvaleric acid, lauric acid, and polyethylene glycol (for example, the commercial wetting additive based on fatty acid esters, Solsperse 39000 from Th. Goldschmidt) are mixed and dispersed.

### 2.5. Preparation of a Wax Dispersion (BC-W)

6.0 parts by weight of the polyethylene wax EVA 1 from BASF AG (commercial polyethylene wax based on an ethylene/vinyl acetate copolymer, with a melting point of 87-92° C., an Ubbelohde drop point of about 95° C., and a weight-average molecular weight of about 6500 g/mol) and 40.0 parts by weight of xylene are dissolved with slow stirring at 100° C. With further stirring, the solution is cooled to 70° C. and admixed slowly with 54.0 parts by weight of butyl acetate (technical grade, approximately 85% pure), with desired precipitation of wax beginning. With further stirring the dispersion is left to cool additionally to 35° C.

### 2.6. Preparation of a Paste of an Aluminum Effect Pigment (BC-E)

The paste is prepared from 33.3 parts by weight of a commercial nonleafing aluminum effect pigment paste of silver dollar type with an average particle size of 14 μm (Metallux 2192 from Eckart), 33.3 parts by weight of butyl acetate, and 33.4 parts by weight of the acrylate binder (BC-B) described under 2.1., with stirring.

### 2.7. Preparation of an Aerosil Paste (BC-A)

A laboratory mill with stirrer mechanism from Vollrath is charged with 100.0 g of grinding charge consisting of 30.0 parts by weight of the acrylate binder (BC-B) described under 2.1., 47.0 parts by weight of solvent naphtha 160/180, 10.0 parts by weight of butanol, and 13.0 parts by weight of Aerosil R805 (commercial Aerosil from Degussa), and this initial charge is ground with water cooling for 30 minutes. It is subsequently separated off from the quartz sand.

### 2.8. Preparation of a Barium Sulfate Paste (BC-BP)

A laboratory mill with stirrer mechanism from Vollrath is charged with 100 g of grinding charge consisting of 19.5 parts by weight of the acrylate binder (BC-B) described under 2.1., 10.7 parts by weight of solvent naphtha 160/180, 0.6 part by weight of Bentone 34 (commercial rheological additive from Elementis Specialties), 0.2 part by weight of ethanol, and 65.0 parts by weight of Blanc Fixe Micro (commercial barium sulfate from Sachtleben), and 4.0 parts by weight of butyl acetate and this initial charge is ground with water cooling for 30 minutes. It is subsequently separated off from the quartz sand.

### 2.9. Preparation of a White Paste (BC-WP)

A laboratory mill with stirrer mechanism from Vollrath was charged with 800.0 g of grinding charge consisting of 152.0 parts by weight of the acrylate binder (BC-B) described under 2.1., 33.6 parts by weight of pentyl propionate, 6.4 parts by weight of Bentone 34, and 528.0 parts by weight of TiPure® R902 (commercial titanium dioxide from DuPont de Nemours and Company), together with 1100.0 parts by weight of quartz sand (grain size 0.7-1 mm), and this charge was dispersed with water cooling for 30 minutes. Subsequently the quartz sand was separated off.

### 2.10. Preparation of a CAB Solution (BC-C)

In a receiver vessel, 76.0 parts by weight of butyl acetate are mixed with 24.0 parts by weight of CAB 551-0.2 (commercial cellulose acetobutyrate from Eastman) for 30 minutes.

### 2.11. Preparation of the Millbase U-BC-V0 for the Solid-Color Basecoat Materials of the Inventive Multicoat Paint Systems, and Comparative Solid-Color Basecoat Materials

For the preparation of the solid-color basecoat materials U-BC-V3 and U-BC-V6 of inventive multicoat paint systems, and of solid-color basecoat materials of noninventive multicoat paint systems, U-BC-V1, U-BC-V2, U-BC-V4, and U-BC-V5, first of all a millbase U-BC-V0 is prepared by mixing and homogenizing of the following constituents:

18.0 parts by weight of the polymer microparticles (BM-M) described under 2.3.,

1.3 parts by weight of pentyl propionate,

3.0 parts by weight of butyl acetate,

9.0 parts by weight of a commercial hexamethoxymethyl/butyl-melamine resin,

0.1 part by weight of a commercial wetting additive based on polybutyl acrylate resin,

3.5 parts by weight of the Aerosil paste (BC-A) described under 2.7.,

4.6 parts by weight of the BaSO₄ paste (BC-BP) described under 2.8.,

40.0 parts by weight of the white paste (BC-WP) described under 2.9.,

12.5 parts by weight of the binder (BC-B) described under 2.1.,

2.5 parts by weight of the CAB solution (BC-C) described under 2.10.,

0.5 part by weight of a commercial hydroxyphenylbenzotriazole-based UV absorber,

0.3 part by weight of ethanol, and

2.2 parts by weight of butyl acetate.

2.11.1. Preparation of a Solid-Color Basecoat Material UV-BC-V1 (Comparative with Nonblocked DDBSA Catalyst)

To prepare the solid-color basecoat material UV-BC-V1, 97.5 parts by weight of the millbase U-BC-V0 from preparation example 2.11. were admixed with 0.9 part by weight of a commercial nonblocked dodecylbenzenesulfonic acid (DDBSA) catalyst (Nacure® 5076 from King Industries, Inc.) and adjusted with 17.0 parts by weight of butyl acetate at 23° C. to a spray viscosity of 23 sec in the Ford 3 flow cup. Thereafter the basecoat material U-BC-V1 had a solids content, based on the total weight of the basecoat material, of 51.7% by weight (1 h/125° C.).

2.11.2. Preparation of a Comparative Solid-Color Basecoat Material U-BC-V2 (Comparative with Amine-Blocked DDBSA Catalyst)

To prepare the solid-color basecoat material U-BC-V2, 97.5 parts by weight of the millbase U-BC-V0 from preparation example 2.11. were admixed with 2.5 parts by weight of a commercial amine-blocked dodecylbenzenesulfonic acid (DDBSA) catalyst (Nacure® 5225 from King Industries, Inc.) and adjusted with 18.0 parts by weight of butyl acetate at 23° C. to a spray viscosity of 23 sec in the Ford 3 flow cup. Thereafter the noninventive basecoat material U-BC-V2 had a solids content, based on the total weight of the basecoat material, of 50.4% by weight (1 h/125° C.).

2.11.3. Preparation of the Solid-Color Basecoat Material U-BC-V3 (with Epoxy-Isocyanate-Blocked DDBSA Catalyst of Formula (II))

To prepare the solid-color basecoat material U-BC-V3, 97.5 parts by weight of the millbase U-BC-V0 from preparation example 2.11. were admixed with 2.5 parts by weight of a commercial epoxy-isocyanate-blocked dodecylbenzenesulfonic acid (DDBSA) catalyst (Nacure® 5414 from King Industries, Inc.) and adjusted with 17.0 parts by weight of butyl acetate at 23° C. to a spray viscosity of 23 sec in the Ford 3 flow cup. Thereafter the inventively employable basecoat material U-BC-V3 had a solids content, based on the total weight of the basecoat material, of 51.1% by weight (1 h/125° C.).

2.11.4. Preparation of a Comparative Solid-Color Basecoat Material U-BC-V4 (Comparative with Nonblocked p-TSA Catalyst)

To prepare the solid-color basecoat material U-BC-V4, 97.5 parts by weight of the millbase U-BC-V0 from preparation example 2.11. were admixed with 1.6 parts by weight of a commercial nonblocked para-toluenesulfonic acid (p-TSA) catalyst (K-Cure® 1040 from King Industries, Inc.) and adjusted with 17.0 parts by weight of butyl acetate at 23° C. to a spray viscosity of 23 sec in the Ford 3 flow cup. Thereafter the basecoat material U-BC-V4 had a solids content, based on the total weight of the basecoat material, of 51.8% by weight (1 h/125° C.).

2.11.5. Preparation of a Comparative Solid-Color Basecoat Material U-BC-V5 (Comparative with Amine-Blocked p-TSA Catalyst)

To prepare the noninventive solid-color basecoat material U-BC-V5, 97.5 parts by weight of the millbase U-BC-V0 from preparation example 2.11. were admixed with 2.5 parts by weight of a commercial amine-blocked para-toluenesulfonic acid (p-TSA) catalyst (Nacure® 2500 from King Industries, Inc.) and adjusted with 17.0 parts by weight of butyl acetate at 23° C. to a spray viscosity of 23 sec in the Ford 3 flow cup. Thereafter the noninventive basecoat material U-BC-VS had a solids content, based on the total weight of the basecoat material, of 50.8% by weight (1 h/125° C.).

2.11.6. Preparation of the Solid-Color Basecoat Material U-BC-V6 (with Epoxy-Blocked p-TSA Catalyst of Formula (I))

To prepare the solid-color basecoat material U-BC-V6, 97.5 parts by weight of the millbase U-BC-V0 from preparation example 2.11. were admixed with 2.5 parts by weight of a commercial epoxy-blocked para-toluenesulfonic acid (p-TSA) catalyst (Cycat® VXK 6357 from Cytec Surface Specialties) and adjusted with 17.0 parts by weight of butyl acetate at 23° C. to a spray viscosity of 23 sec in the Ford 3 flow cup. Thereafter the inventively employable basecoat material U-BC-V6 had a solids content, based on the total weight of the basecoat material, of 51.4% by weight (1 h/125° C.).

### 2.12. Preparation of the Millbase M-BC-V0 for the Metallic Basecoat Materials of the Inventive Multicoat Paint System, and Comparative Metallic Basecoat Materials

For the preparation of the metallic basecoat materials M-BC-V3 and M-BC-V6 of the inventive multicoat paint system, and of metallic basecoat materials of noninventive multicoat paint systems, M-BC-V1, M-BC-V2, M-BC-V4, and M-BC-V5, first of all a millbase M-BC-V0 is prepared by mixing and homogenizing of the following constituents:

10.0 parts by weight of the wax dispersion (BC-W) described under 2.5.,

22.0 parts by weight of the polymer microparticles (BC-M) described under 2.3.,

11.5 parts by weight of a commercial hexamethoxymethyl/butyl-melamine resin,

8.0 parts by weight of the inorganic particles (BC-N) described under 2.4.,

0.5 part by weight of a commercial, silicone-free wetting additive based on an amine resin-modified acrylic copolymer,

0.5 part by weight of a commercial hydroxyphenylbenzotriazole-based UV absorber,

21.0 parts by weight of the binder (BC-B) described under 2.1.,

3.0 parts by weight of the CAB solution (BC-C) described under 2.10.,

20.4 parts by weight of an aluminum effect pigment paste (BC-E) described under 2.6., and

1.1 parts by weight of butyl acetate.

2.12.1. Preparation of a Comparative Metallic Basecoat Material M-BC-V1 (Comparative with Nonblocked DDBSA Catalyst)

To prepare the metallic basecoat material M-BC-V1, 98.0 parts by weight of the millbase M-BC-V0 from preparation example 2.12. were admixed with 0.7 part by weight of a commercial nonblocked dodecylbenzenesulfonic acid (DDBSA) catalyst (Nacure® 5076 from King Industries, Inc.) and adjusted with 2.0 parts by weight of butyl acetate at 23° C. to a spray viscosity of 23 sec in the Ford 3 flow cup. Thereafter the basecoat material M-BC-V1 had a solids content, based on the total weight of the basecoat material, of 40.8% by weight (1 h/125° C.).

2.12.2. Preparation of a Comparative Metallic Basecoat Material M-BC-V2 (Comparative with Amine-Blocked DDBSA Catalyst)

To prepare the metallic basecoat material M-BC-V2, 98.0 parts by weight of the millbase M-BC-V0 from preparation example 2.12. were admixed with 2.0 parts by weight of a commercial amine-blocked dodecylbenzenesulfonic acid (DDBSA) catalyst (Nacure® 5225 from King Industries, Inc.) and adjusted with 2.0 parts by weight of butyl acetate at 23° C. to a spray viscosity of 23 sec in the Ford 3 flow cup. Thereafter the noninventive basecoat material M-BC-V2 had a solids content, based on the total weight of the basecoat material, of 40.4% by weight (1 h/125° C.).

2.12.3. Preparation of the Metallic Basecoat Material M-BC-V3 (with Epoxy-Isocyanate-Blocked DDBSA Catalyst of Formula (II))

To prepare the metallic basecoat material M-BC-V3, 98.0 parts by weight of the millbase M-BC-V0 from preparation example 2.12. were admixed with 2.0 parts by weight of a commercial epoxy-isocyanate-blocked dodecylbenzenesulfonic acid (DDBSA) catalyst (Nacure® 5414 from King Industries, Inc.) and adjusted with 3.0 parts by weight of butyl acetate at 23° C. to a spray viscosity of 23 sec in the Ford 3 flow cup. Thereafter the basecoat material M-BC-V3 had a solids content, based on the total weight of the basecoat material, of 40.1% by weight (1 h/125° C.).

2.12.4. Preparation of a Comparative Metallic Basecoat Material M-BC-V4 (Comparative with Nonblocked p-TSA Catalyst)

To prepare the metallic basecoat material M-BC-V4, 98.0 parts by weight of the millbase M-BC-V0 from preparation example 2.12. were admixed with 1.3 parts by weight of a commercial nonblocked para-toluenesulfonic acid (p-TSA) catalyst (K-Cure® 1040 from King Industries, Inc.) and adjusted with 2.0 parts by weight of butyl acetate at 23° C. to a spray viscosity of 23 sec in the Ford 3 flow cup. Thereafter the basecoat material M-BC-V4 had a solids content, based on the total weight of the basecoat material, of 41.1% by weight (1 h/125° C.).

2.12.5. Preparation of a Comparative Metallic Basecoat Material M-BC-V5 (Comparative with Amine-Blocked p-TSA Catalyst)

To prepare the metallic basecoat material M-BC-V5, 98.0 parts by weight of the millbase M-BC-V0 from preparation example 2.12. were admixed with 2.0 parts by weight of a commercial amine-blocked para-toluenesulfonic acid (p-TSA) catalyst (Nacure® 2500 from King Industries, Inc.) and adjusted with 2.0 parts by weight of butyl acetate at 23° C. to a spray viscosity of 23 sec in the Ford 3 flow cup. Thereafter the basecoat material M-BC-V5 had a solids content, based on the total weight of the basecoat material, of 40.8% by weight (1 h/125° C.).

2.12.6. Preparation of a Metallic Basecoat Material M-BC-V6 (with Epoxy-Blocked p-TSA Catalyst of Formula (I))

To prepare the inventively employable metallic basecoat material M-BC-V6, 98.0 parts by weight of the millbase M-BC-V0 from preparation example 2.12. were admixed with 2.0 parts by weight of a commercial epoxy-blocked para-toluenesulfonic acid (p-TSA) catalyst (Cycat® VXK 6357 from Cytec Surface Specialties) and adjusted with 4.0 parts by weight of butyl acetate at 23° C. to a spray viscosity of 23 sec in the Ford 3 flow cup. Thereafter the basecoat material M-BC-V6 had a solids content, based on the total weight of the basecoat material, of 40.4% by weight (1 h/125° C.).

### 3. Experimental Results

### 3.1. Storage Stability Testing of the Clearcoat, Solid-Color Basecoat, and Metallic Basecoat Materials

The storage stability of the example coating materials CC-V1 to CC-V6, U-BC-V1 to U-BC-V6, and M-BC-V1 to M-BC-V6 was determined by storing these example coating materials for 3 days at a temperature of 60° C. and measuring the flow viscosity in the Ford Cup 3 at 23° C. before and after storage. The results are set out in table 1.

TABLE 1
Viscosity of example coating materials CC-V1 to CC-V6,
U-BC-V1 to U-at BC-V6, and M-BC-V1 to M-BC-V6 before
and after storage for 3 days a temperature of 60° C.

| | | Viscosity | Viscosity |
|---|---|---|---|
| | | before | after |
| Example coating material | | storage | storage |
| CC-V1 | Nonblocked DDBSA | 48 sec | 256 sec |
| CC-V2 | Amine-blocked DDBSA | 48 sec | 83 sec |
| CC-V3 | Epoxy-isocyanate-blocked DDBSA | 48 sec | 79 sec |
| CC-V4 | Nonblocked p-TSA | 48 sec | 280 sec |
| CC-V5 | Amine-blocked p-TSA | 48 sec | 96 sec |
| CC-V6 | Epoxy-blocked p-TSA | 48 sec | 93 sec |
| U-BC-V1 | Nonblocked DDBSA | 23 sec | 301 sec |
| U-BC-V2 | Amine-blocked DDBSA | 23 sec | 33 sec |
| U-BC-V3 | Epoxy-isocyanate-blocked DDBSA | 23 sec | 31 sec |
| U-BC-V4 | Nonblocked p-TSA | 23 sec | 245 sec |
| U-BC-V5 | Amine-blocked p-TSA | 23 sec | 29 sec |
| U-BC-V6 | Epoxy-blocked p-TSA | 23 sec | 34 sec |
| M-BC-V1 | Nonblocked DDBSA | 23 sec | 209 sec |
| M-BC-V2 | Amine-blocked DDBSA | 23 sec | 35 sec |
| M-BC-V3 | Epoxy-isocyanate-blocked DDBSA | 23 sec | 33 sec |
| M-BC-V4 | Nonblocked p-TSA | 23 sec | 222 sec |
| M-BC-V5 | Amine-blocked p-TSA | 23 sec | 31 sec |
| M-BC-V6 | Epoxy-blocked p-TSA | 23 sec | 34 sec |

The example coating materials with nonblocked catalysts exhibit a distinct disadvantage in storage stability. The coating materials with amine-blocked catalysts and those with epoxy-(isocyanate)-blocked catalysts show only a slight increase in viscosity on storage.

### 3.2. Production of Multicoat Paint Systems V1 to V24

For the testing of the colorimetric properties of example coating materials CC-V1 to CC-V6, U-BC-V1 to U-BC-V6, and M-BC-V1 to M-BC-V6, test panels with dimensions of 10 cm×20 cm were prepared in a customary and known way. This was done by coating coil-coated panels with a commercial, conventional, white or gray, polyester-based surfacer from BASF Coatings AG, after which the resulting surfacer films were flashed at 20° C. for 5 minutes and a relative humidity of 65% and baked in a forced-air oven at a panel temperature of 165° C. for 5 minutes.

The test panels with white surfacer were used for the coating of the solid-color basecoat materials U-BC; the test panels with gray surfacer were used for the metallic basecoat materials M-BC.

### 3.2.1. Production of Multicoat Paint Systems V1 to V6

After the cooling of the test panels to 20° C., in a first series the solid-color basecoat materials U-BC-V1 to U-BC-V6 were applied by single ESTA application with a dry film thickness of 25 μm. Subsequently the basecoat films were flashed for 5 minutes and overcoated with the clearcoat materials CC-V1 to CC-V6, with a dry film thickness of about 45 μm. In this series, basecoat material U-BC-V1 was combined with clearcoat material CC-V1 to give multicoat paint system V1, basecoat material U-BC-V2 was combined with clearcoat material CC-V2 to give multicoat paint system V2, and so on. Thereafter the basecoat films and the clearcoat films were baked at a panel temperature of 140° C. for 10 minutes. A second series of test panels was overbaked at a panel temperature of 160° C. for 10 minutes.

### 3.2.2. Production of Multicoat Paint Systems V7 to V12

In a second series, the test panels with gray surfacer were coated with the basecoat materials M-BC-V1 to M-BC-V6 by double ESTA application with a dry film thickness of 18 μm. Subsequently the basecoat films were flashed for 5 minutes and overcoated with the clearcoat materials CC-V1 to CC-V6, with a dry film thickness of about 45 μm. In this series, basecoat material M-BC-V1 was combined with clearcoat material CC-V1 to give multicoat paint system V7, basecoat material M-BC-V2 was combined with clearcoat material CC-V2 to give multicoat paint system V8, and so on. Thereafter the basecoat films and the clearcoat films were baked at a panel temperature of 140° C. for 10 minutes. An identical series of test panels was overbaked at a panel temperature of 160° C. for 10 minutes.

### 3.2.3. Production of Multicoat Paint Systems V13 to V18

In a third series, the test panels with white surfacer were coated with the basecoat materials U-BC-V1 to U-BC-V6 by single ESTA application with a dry film thickness of 25 μm. Subsequently the basecoat films were flashed for 5 minutes and overcoated with the clearcoat material CC-V2, with a dry film thickness of about 45 μm. In this series, basecoat material U-BC-V1 was combined with clearcoat material CC-V2 to give multicoat paint system V13, basecoat material U-BC-V2 was combined with clearcoat material CC-V2 to give multicoat paint system V14, and so on. Thereafter the basecoat films and the clearcoat films were baked at a panel temperature of 140° C. for 10 minutes. A second series of test panels was overbaked at a panel temperature of 160° C. for 10 minutes.

### 3.2.4. Production of Multicoat Paint Systems V19 to V24

In a fourth series, the test panels with white surfacer were coated with the basecoat material U-BC-V2 by single ESTA application with a dry film thickness of 25 μm. Subsequently the basecoat films were flashed for 5 minutes and overcoated with the clearcoat materials CC-V1 to CC-V6, with a dry film thickness of about 45 μm. In this series, basecoat material U-BC-V2 was combined with clearcoat material CC-V1 to give multicoat paint system V19, basecoat material U-BC-V2 was combined with clearcoat material CC-V2 to give multicoat paint system V20, and so on. Thereafter the basecoat films and the clearcoat films were baked at a panel temperature of 140° C. for 10 minutes. A second series of test panels was overbaked at a panel temperature of 160° C. for 10 minutes.

The multicoat paint systems V3, V6, V9, and V12 here are the multicoat paint systems of the invention. The other combinations resulted in the noninventive multicoat paint systems of the comparative experiments.

### 3.3. Testing of the Resulting Multicoat Paint Systems V1 to V24

Multicoat paint systems V1 and V24 were measured using a spectrophotometer from X-Rite (MA68 II Multi-Angle Spectrophotometer), and the yellowing number db* was recorded. As a shade reference for multicoat paint systems V1 to V6, multicoat paint system V1, baked at 140° C., was used. For V7 to V12, V7 baked at 140° C. was used; for V13 to V18, V13, baked at 140° C., was used; and for V19 to V24, V19, baked at 140° C., was used.

The relative yellowing values determined for the metallic multicoat paint systems were calculated using the average value of the viewing angles 15°, 25°, 45°, 75°, and 110°, in accordance with the following formula:

db*₁₅₋₁₁₀=((b*₁₅^{p}−b*₁₅^{r})+(b*₂₅^{p}−b*₂₅^{r})+(b*₄₅^{p}−b*₄₅^{r})+(b*₇₅^{p}−b*₇₅^{r})+(b*₁₁₀^{p}−b*₁₁₀^{r})/5.

In the formula, reference r is the multicoat paint system V7 baked at 140° C., and sample p is experiment V7 to V12.

For solid-color white shades, a yellowing of db*0.5 is clearly visible.

The yellowing results are set out in table 2.

TABLE 2
Yellowing numbers of multicoat paint systems V1 to V24.

| | | | | | Yellowing | Yellowing |
|---|---|---|---|---|---|---|
| Multicoat paint system | | | | | number | number |
| | | Basecoat | | Clearcoat | (140° C.) | (160° C.) |
| V1 | = | U-BC-V1 | + | CC-V1 | reference | 0.5 |
| V2 | = | U-BC-V2 | + | CC-V2 | 1.2 | 2.1 |
| V3 | = | U-BC-V3 | + | CC-V3 | 0.1 | 0.7 |
| V4 | = | U-BC-V4 | + | CC-V4 | 0.2 | 0.7 |
| V5 | = | U-BC-V5 | + | CC-V5 | 1.4 | 2.5 |
| V6 | = | U-BC-V6 | + | CC-V6 | 0.2 | 0.6 |
| V7 | = | M-BC-V1 | + | CC-V1 | reference | 0.3 |
| V8 | = | M-BC-V2 | + | CC-V2 | 0.5 | 0.9 |
| V9 | = | M-BC-V3 | + | CC-V3 | 0.1 | 0.3 |
| V10 | = | M-BC-V4 | + | CC-V4 | 0.0 | 0.2 |
| V11 | = | M-BC-V5 | + | CC-V5 | 0.5 | 1.1 |
| V12 | = | M-BC-V6 | + | CC-V6 | 0.0 | 0.3 |
| V13 | = | U-BC-V1 | + | CC-V2 | reference | 0.8 |
| V14 | = | U-BC-V2 | + | CC-V2 | 0.8 | 1.7 |
| V15 | = | U-BC-V3 | + | CC-V2 | 0.1 | 1.1 |
| V16 | = | U-BC-V4 | + | CC-V2 | 0.2 | 1.2 |
| V17 | = | U-BC-V5 | + | CC-V2 | 1.2 | 2.3 |
| V18 | = | U-BC-V6 | + | CC-V2 | 0.2 | 1.2 |
| V19 | = | U-BC-V2 | + | CC-V1 | reference | 1.0 |
| V20 | = | U-BC-V2 | + | CC-V2 | 0.7 | 1.8 |
| V21 | = | U-BC-V2 | + | CC-V3 | 0.1 | 1.3 |
| V22 | = | U-BC-V2 | + | CC-V4 | 0.1 | 1.4 |
| V23 | = | U-BC-V2 | + | CC-V5 | 1.1 | 2.4 |
| V24 | = | U-BC-V2 | + | CC-V6 | 0.3 | 1.5 |

The results compiled in table 2 underline the fact that the inventive multicoat paint systems V3, V6, V9, and V12 exhibit virtually no yellowing both at 140° C. and at an overbaking temperature of 160° C. In addition, these multicoat paint systems have a good storage stability (see above).

For the noninventive multicoat paint systems V2, V5, V8, and V11, high yellowing numbers were found. The noninventive multicoat paint systems V1, V4, V7, and V10 do show good yellowing values, but have a poor storage stability.

The noninventive multicoat paint systems V13 to V24, in which either only the basecoat material or only the clearcoat material contains a compound of the formula (I) or (II), show very good yellowing results at a temperature of 140° C. Where these multicoat paint systems are overbaked (160° C.), however, there is a distinct increase in the yellowing numbers.

Accordingly only the multicoat paint systems of the invention exhibit low yellowing on overbaking of the coating (160° C.) in conjunction with good storage stability.

1-14. (canceled)

15. A method of coating a substrate with at least one coat each of a nonaqueous basecoat material and a nonaqueous clearcoat material wherein the basecoat material and the clearcoat material each comprise independently 0.5% to 3.0% by weight, based on the total weight of the respective coating material, of at least one of:
A. an epoxy-sulfonic acid compound of formula (I) 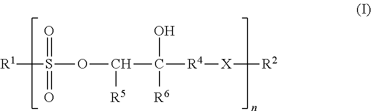
wherein,
n is from 1 to 10,
R¹ is at least one of the group consisting of a monovalent or divalent C₁-C₁₈ alkyl radical, a monovalent or divalent C₁-C₁₈ alkylene radical, a monoalkylated or dialkylated C₁-C₁₈ phenyl radical, and a monoalkylated or dialkylated C₁-C₁₈ naphthyl radical,
R⁵ and R⁶ independently are a hydrogen atom or a C₁-C₁₂ alkyl radical, or R⁵ and R⁶ together are a C₆-C₁₂ cycloalkyl radical,
R² is at least one of the group consisting of a hydrogen atom, a monovalent or polyvalent C₁-C₁₈ alkyl radical, an unsubstituted or substituted bisphenol A radical, and an unsubstituted or substituted bisphenol F radical, and
X is a carbonyl group or an oxygen atom, X being optional,
and either
a. R⁴ is a hydrogen atom and the radicals R² and X are absent, or
b. R⁴ is a methylene radical,
wherein the compound according to the formula (I) comprises a number-average molecular weight of about 350 to 2000 g/mol, and, wherein if n>1, at least one of the radicals R¹ or R² is at least divalent,
or;
B. an epoxy-isocyanate-blocked sulfonic acid compound of formula (II) 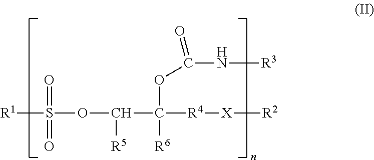
wherein
R¹, R², R⁴, R⁵, R⁶, X, and n have the same definition as in the compound of the formula (I) above and
R³ is at least one of the group consisting of a C₁-C₁₈ alkyl radical, a C₁-C₁₈ alkenyl radical, a C₁-C₁₈ cycloalkyl radical, a C₁-C₁₈ aryl radical, and a substituted or unsubstituted polymer radical, wherein if n>1, at least one of the radicals R¹, R² or R³ is at least divalent, and
the compound according to the formula (II) comprises a number-average molecular weight of at least 1000 g/mol,
wherein the method comprises the steps of:
1) applying at least one coat of the nonaqueous basecoat material having a solids fraction of at least 35% by weight, based on the total weight of the basecoat material;
2) applying at least one coat of the nonaqueous clearcoat material having a solids fraction of at least 50% by weight, based on the total weight of the clearcoat material; and
3) baking the nonaqueous basecoat and clearcoat materials with a supply of energy in excess of that needed for complete crosslinking.

16. The method of claim 15, wherein at least one of the basecoat material or the clearcoat material is applied via spraying.

17. The method of claim 16, wherein the spraying is accomplished via electrostatic spray application.

18. The method of claim 15, wherein said basecoat material is applied in two coats.

19. The method of claim 15, wherein said two coats include a first coat that is applied via electrostatic spray application and a second coat that is applied pneumatically.

20. The method of claim 15, wherein the supply in energy in excess of that needed for complete crosslinking includes a baking temperature above 140° C. for 10 minutes.

21. The method of claim 20, wherein the baking temperature is at least 160° C.

22. The method of claim 15, wherein the supply in energy in excess of that needed for complete crosslinking includes a baking temperature of at least 140° C. for more than 10 minutes.

23. A method of preventing or reducing yellowing when overbaking a substrate having at least one coat each of a nonaqueous basecoat material and a nonaqueous clearcoat material wherein the basecoat material and the clearcoat material each comprise independently 0.5% to 3.0% by weight, based on the total weight of the respective coating material, of at least one of:
A. an epoxy-sulfonic acid compound of formula (I) 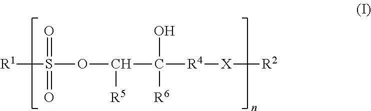
wherein,
n is from 1 to 10,
R¹ is at least one of the group consisting of a monovalent or divalent C₁-C₁₈ alkyl radical, a monovalent or divalent C₁-C₁₈ alkylene radical, a monoalkylated or dialkylated C₁-C₁₈ phenyl radical, and a monoalkylated or dialkylated C₁-C₁₈ naphthyl radical,
R⁵ and R⁶ independently are a hydrogen atom or a C₁-C₁₂ alkyl radical, or R⁵ and R⁶ together are a C₆-C₁₂ cycloalkyl radical,
R² is at least one of the group consisting of a hydrogen atom, a monovalent or polyvalent C₁-C₁₈ alkyl radical, an unsubstituted or substituted bisphenol A radical, and an unsubstituted or substituted bisphenol F radical, and
X is a carbonyl group or an oxygen atom, X being optional,
and either
c. R⁴ is a hydrogen atom and the radicals R² and X are absent, or
d. R⁴ is a methylene radical,
wherein the compound according to the formula (I) comprises a number-average molecular weight of about 350 to 2000 g/mol, and, wherein if n>1, at least one of the radicals R¹ or R² is at least divalent,
or;
B. an epoxy-isocyanate-blocked sulfonic acid compound of formula (II) 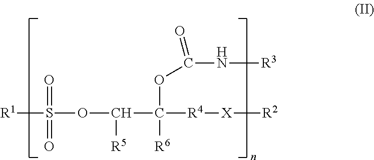
wherein
n is from 1 to 5,
R¹, R², R⁴, R⁵, R⁶, X, and n have the same definition as in the compound of the formula (I) above and
R³ is at least one of the group consisting of a C₁-C₁₈ alkyl radical, a C₁-C₁₈ alkenyl radical, a C₁-C₁₈ cycloalkyl radical, a C₁-C₁₈ aryl radical, and a substituted or unsubstituted polymer radical, wherein if n>1, at least one of the radicals R¹, R² or R³ is at least divalent, and
the compound according to the formula (II) comprises a number-average molecular weight of at least 1000 g/mol,
wherein the method comprises the steps of:
1) applying at least one coat of the nonaqueous basecoat material having a solids fraction of at least 35% by weight, based on the total weight of the basecoat material;
2) applying at least one coat of the nonaqueous clearcoat material having a solids fraction of at least 50% by weight, based on the total weight of the clearcoat material; and
3) baking the basecoat and clearcoat materials with a supply of energy in excess of that needed for complete crosslinking.

24. The method of claim 23, wherein at least one of the basecoat material or the clearcoat material is applied via spraying.

25. The method of claim 24, wherein the spraying is accomplished via electrostatic spray application.

26. The method of claim 23, wherein said basecoat material is applied in two coats.

27. The method of claim 23, wherein said two coats include a first coat that is applied via electrostatic spray application and a second coat that is applied pneumatically.

28. The method of claim 23, wherein the supply in energy in excess of that needed for complete crosslinking includes a baking temperature above 140° C. for 10 minutes.

29. The method of claim 28 wherein the baking temperature is at least 160° C.

30. The method of claim 23, wherein the supply in energy in excess of that needed for complete crosslinking includes a baking temperature of at least 140° C. for more than 10 minutes.

31. A multicoat paint system for spray application to a substrate, the multicoat paint system comprising:
i. at least one basecoat of a nonaqueous basecoat material having a solids fraction of at least 35% by weight, based on the total weight of the basecoat material; and
ii. at least one clearcoat of a nonaqueous clearcoat material having a solids fraction of at least 50% by weight, based on the total weight of the clearcoat material;
wherein the basecoat material and the clearcoat material each comprise independently 1.5% to 3.0% by weight, based on the total weight of the respective coating material, of at least one of
A. an epoxy-sulfonic acid compound of formula (I) 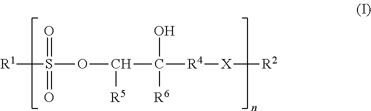
wherein
n is from 1 to 5,
R¹ is at least one of the group consisting of a monovalent or divalent C₁-C₁₈ alkyl radical, a monovalent or divalent C₁-C₁₈ alkylene radical, a monoalkylated or dialkylated C₁-C₁₈ phenyl radical, and a monoalkylated or dialkylated C₁-C₁₈ naphthyl radical,
R⁵ and R⁶ independently are a hydrogen atom or a C₁-C₁₂ alkyl radical, or R⁵ and R⁶ together are a C₆-C₁₂ cycloalkyl radical,
and either
e. R⁴ is a hydrogen atom and the radicals R² and X are absent, or
f. R⁴ is a methylene radical,
R² is at least one of the group consisting of a hydrogen atom, a monovalent or polyvalent C₁-C₁₈ alkyl radical, an unsubstituted or substituted bisphenol A radical, and an unsubstituted or substituted bisphenol F radical, and
X is a carbonyl group or an oxygen atom, X being optional,
wherein the compound according to the formula (I) comprises a number-average molecular weight of about 500 to 1 800 g/mol, and, wherein if n>1, at least one of the radicals R¹ or R² is at least divalent,
or
B. an epoxy-isocyanate-blocked sulfonic acid compound of formula (II) 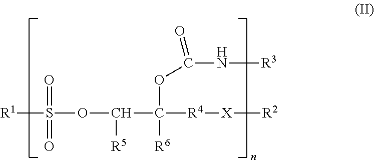
wherein
n is from 1 to 5,
R¹, R², R⁴, R⁵, R⁶, X, and n have the same definition as in the compound of the formula (I) above and
R³ is at least one of the group consisting of a C₁-C₁₈ alkyl radical, a C₁-C₁₈ alkenyl radical, a C₁-C₁₈ cycloalkyl radical, a C₁-C₁₈ aryl radical, and a substituted or unsubstituted polymer radical, wherein if n>1, at least one of the radicals R¹, R² or R³ is at least divalent, and
the compound according to the formula (II) comprises a number-average molecular weight of about 1000 to 3000 g/mol,
wherein, when the at least one basecoat and the at least one clearcoat are applied to a substrate via spraying, the multicoat paint system exhibits less yellowing upon overbaking than a multicoat paint system having a basecoat and a clearcoat that do not comprise the epoxy-sulfonic acid compound of the formula (I) or the epoxy-isocyanate-block sulfonic acid compound of the formula (II),
wherein the basecoat material further comprises
a. 15%-50% by weight of at least one binder comprising at least one (meth)acrylate copolymer, which has a number-average molecular weight of about 400 to 5000 g/mol,
b. 5%-30% by weight of at least one melamine resin derivative as crosslinking agent,
c. 0.5% to 49% by weight of at least one colorant comprising a pigment,
d. 30%-65% by weight of at least one organic solvent,
e. 0.05%-40% by weight of at least one auxiliary or additive,
based in each case on the total weight of the basecoat material, the weight fractions of the A and/or the B as present and the a to the e of the basecoat material adding to 100%, and
wherein the clearcoat material further comprises
a. 15%-50% by weight of at least one binder comprising at least one (meth)acrylate copolymer, which has a number-average molecular weight of 400 to 5000 g/mol,
b. 5%-30% by weight of at least one melamine resin derivative as crosslinking agent,
c. 30%-50% by weight of at least one organic solvent,
d. 0.05%-40% by weight of at least one auxiliary or additive,
based in each case on the total weight of the clearcoat material, the weight fractions of the A and/or the B as present and the a to the d of the clearcoat material adding to 100%.

32. The multicoat paint system of claim 31, wherein the at least one of the basecoat material and the clearcoat material, in each case independently of one another, comprise from 1.8% to 2.7% by weight of the at least one compound selected from the group consisting of the formula (I), the formula (II), and a combination thereof based on the total weight of the respective coating material.

33. The multicoat paint system of claim 31, wherein the additive of the basecoat material is selected from the group consisting of polymer microparticles, inorganic particles, waxes, and waxlike compounds.

34. The multicoat paint system of claim 31, further comprising at least one further basecoat of a basecoat material having a solids content of at least 35% by weight, based on the total weight of the further basecoat material, and comprising one or more identical or different compounds selected from the group consisting of the formula (I), the formula (II), and a combination thereof.
